(19) United States
(12) Patent Application Publication
(10) Pub. No.: US 2024/0064379 A1
(43) Pub. Date: Feb. 22, 2024

(54) System and Application for Streaming Video

(71) Applicant: Baakhapaa IT and Marketing Solutions LLC, Burleson, TX (US)

(72) Inventors: Rakesh Rajbhat, Burleson, TX (US); Nadish Manandhar, Kathmandu (NP)

(73) Assignee: Baakhapaa IT and Marketing Solutions LLC, Burleson, TX (US)

(21) Appl. No.: 17/889,553

(22) Filed: Aug. 17, 2022

(51) Int. Cl. H04N 21/4784; H04N 21/8545

(52) U.S. Cl. CPC H04N 21/4784; H04N 21/8545

(57) ABSTRACT

A system for streaming digital content includes a mobile device, a mobile application, and a backend application. The mobile application includes a form of digital content, at least one quiz, a reward subsystem, and a marketplace. The quiz material is related to the digital content. The mobile application is configured for use on the mobile device.

### BACKGROUND

### 1. Field of the Invention

The present application relates to software application systems. In particular, the present application relates to a system for streaming video and providing a reward program through a software application.

### 2. Description of Related Art

Currently, many software applications provide some form of reward system for users. Reward systems may include virtual currencies designed for in-app purchases, the in-app purchases being centered around either a digital reward or some physical item related to the app itself. Other reward systems may include a point system based on how many dollars are spent within the application. Points earned may then be redeemed for various items, such as gift cards, physical items, or future discounts.

Some video streaming applications offer rewards in different ways. Product and service advertisements are often used as a revenue generation tool for the application, so the ads are streamed to the user for a set period of time. Some applications provide users with an option to watch one long advertisement before starting a video in order to prevent advertisements from interrupting an already in progress video. Other applications offer ad-free streaming to users for some recurring fee. While not traditional “rewards” in the sense of receiving tangible items, the redirection or avoidance of advertisements is a common system used by video streaming applications as a benefit to users.

Although the aforementioned software application systems represent great strides in the field of heat transfer and tube transitions, many shortcomings remain.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 is a user diagram of an application for streaming video according to a preferred embodiment of the present application;

FIG. 2 is an admin diagram of the application for streaming video of FIG. 1;

FIG. 3A is a login screenshot of the application for streaming video of FIG. 1;

FIG. 3B is a login verification screenshot of the application for streaming video of FIG. 1;

FIG. 3C is an email verification screenshot of the application for streaming video of FIG. 1;

FIG. 4A is a registration page screenshot of the application for streaming video of FIG. 1;

FIG. 4B is a registration page screenshot of the application for streaming video of FIG. 1;

FIG. 5A is a quiz page screenshot of the application for streaming video of FIG. 1;

FIG. 5B is a quiz page screenshot of the application for streaming video of FIG. 1;

FIG. 5C is a test episode screenshot of the application for streaming video of FIG. 1;

FIG. 5D is a quiz start screenshot of the application for streaming video of FIG. 1;

FIG. 5E is a quiz screenshot of the application for streaming video of FIG. 1;

FIG. 5F is a quiz completion screenshot of the application for streaming video of FIG. 1;

FIG. 5G is a profile screenshot of the application for streaming video of FIG. 1;

FIG. 5H is an episode page screenshot of the application for streaming video of FIG. 1;

FIG. 6A is a gift shop screenshot of the application for streaming video of FIG. 1;

FIG. 6B is a marketplace product screenshot of the application for streaming video of FIG. 1;

FIG. 6C is a purchase confirmation screenshot of the application for streaming video of FIG. 1;

FIG. 6D is a profile screenshot of the application for streaming video of FIG. 1;

FIG. 6E is a coin log screenshot of the application for streaming video of FIG. 1;

FIG. 6F is a profile update requirement screenshot of the application for streaming video of FIG. 1;

FIG. 6G is a profile editing screenshot of the application for streaming video of FIG. 1;

FIG. 6H is a profile update confirmation screenshot of the application for streaming video of FIG. 1;

FIG. 7A is a product market screenshot of the application for streaming video of FIG. 1;

FIG. 7B is a marketplace product screenshot of the application for streaming video of FIG. 1;

FIG. 7C is a cart addition confirmation screenshot of the application for streaming video of FIG. 1;

FIG. 7D is a checkout cart screenshot of the application for streaming video of FIG. 1;

FIG. 7E is a checkout confirmation screenshot of the application for streaming video of FIG. 1;

FIG. 8A is an admin dashboard screenshot of the application for streaming video of FIG. 1;

FIG. 8B is a user data screenshot of the application for streaming video of FIG. 1;

FIG. 8C is a user data screenshot of the application for streaming video of FIG. 1;

FIG. 9 is an admin login screenshot of the application for streaming video of FIG. 1;

FIG. 10A is a vendor registration page screenshot of the application for streaming video of FIG. 1;

FIG. 10B is a vendor registration page screenshot of the application for streaming video of FIG. 1;

FIG. 10C is a vendor registration page screenshot of the application for streaming video of FIG. 1;

FIG. 10D is a registration confirmation screenshot of the application for streaming video of FIG. 1;

FIG. 11A is a season overview screenshot of the application for streaming video of FIG. 1;

FIG. 11B is a season creation screenshot of the application for streaming video of FIG. 1;

FIG. 11C is a season creation screenshot of the application for streaming video of FIG. 1;

FIG. 11D is a season creation confirmation screenshot of the application for streaming video of FIG. 1;

FIG. 12A is a season editing screenshot of the application for streaming video of FIG. 1;

FIG. 12B is a season editing confirmation screenshot of the application for streaming video of FIG. 1;

FIG. 13A is an admin profile screenshot of the application for streaming video of FIG. 1;

FIG. 13B is an admin profile screenshot of the application for streaming video of FIG. 1;

FIG. 14A is a roles and permissions page screenshot of the application for streaming video of FIG. 1;

FIG. 14B is a roles and permissions editing screenshot of the application for streaming video of FIG. 1;

FIG. 15A is a category overview screenshot of the application for streaming video of FIG. 1;

FIG. 15B is a category creation screenshot of the application for streaming video of FIG. 1;

FIG. 15C is a category creation confirmation screenshot of the application for streaming video of FIG. 1;

FIG. 16A is a category editing screenshot of the application for streaming video of FIG. 1;

FIG. 16B is a category editing confirmation screenshot of the application for streaming video of FIG. 1;

FIG. 17A is a brand overview screenshot of the application for streaming video of FIG. 1;

FIG. 17B is a brand creation screenshot of the application for streaming video of FIG. 1;

FIG. 17C is a brand creation confirmation screenshot of the application for streaming video of FIG. 1;

FIG. 18A is a brand editing screenshot of the application for streaming video of FIG. 1;

FIG. 18B is a brand editing confirmation screenshot of the application for streaming video of FIG. 1;

FIG. 19A is a product overview screenshot of the application for streaming video of FIG. 1;

FIG. 19B is a product creation screenshot of the application for streaming video of FIG. 1;

FIG. 19C is a product creation screenshot of the application for streaming video of FIG. 1;

FIG. 19D is a product creation confirmation screenshot of the application for streaming video of FIG. 1;

FIG. 20A is a product editing screenshot of the application for streaming video of FIG. 1;

FIG. 20B is a product editing confirmation screenshot of the application for streaming video of FIG. 1;

FIG. 21A is a gift overview screenshot of the application for streaming video of FIG. 1;

FIG. 21B is a gift creation screenshot of the application for streaming video of FIG. 1;

FIG. 21C is a gift creation confirmation screenshot of the application for streaming video of FIG. 1;

FIG. 22A is a gift editing screenshot of the application for streaming video of FIG. 1;

FIG. 22B is a gift editing confirmation screenshot of the application for streaming video of FIG. 1;

FIG. 23A is an announcements overview page screenshot of the application for streaming video of FIG. 1;

FIG. 23B is an announcement creation screenshot of the application for streaming video of FIG. 1;

FIG. 23C is an announcement creation confirmation screenshot of the application for streaming video of FIG. 1;

FIG. 24A is a product request overview page screenshot of the application for streaming video of FIG. 1;

FIG. 24B is a product request approval confirmation screenshot of the application for streaming video of FIG. 1;

FIG. 25A is a vendor request overview page screenshot of the application for streaming video of FIG. 1;

FIG. 25B is a vendor request screenshot of the application for streaming video of FIG. 1;

FIG. 25C is a vendor request approval confirmation screenshot of the application for streaming video of FIG. 1;

FIG. 26 is a vendor profile screenshot of the application for streaming video of FIG. 1;

FIG. 27A is a vendor product editing page screenshot of the application for streaming video of FIG. 1;

FIG. 27B is a vendor product editing page screenshot of the application for streaming video of FIG. 1;

FIG. 28A is an order overview page screenshot of the application for streaming video of FIG. 1;

FIG. 28B is a purchase list screenshot of the application for streaming video of FIG. 1; and

FIG. 29 is a settings page screenshot of the application for streaming video of FIG. 1.

While the assembly of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the application for streaming video according to the present application are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The preferred embodiment of the present invention includes a mobile application and a backend support application, both used in conjunction with some form of electronic device, such as a mobile device or desktop device. Under the preferred embodiment, the mobile application is built using React Native, a software framework used for developing applications on a variety of platforms. Using this framework allows for near-simultaneous development both on Android and iOS platforms. While the preferred embodiment utilizes Android and iOS, it should be appreciated that alternative embodiments of the present invention may be designed for use on alternative platforms, such as Windows, for example. It should be further appreciated that alternative frameworks to React Native may be used for code implementation, while maintaining the purpose and functionality of the present invention.

Under the preferred embodiment, the backend support application utilizes Laravel, a framework for web applications. Similar to the mobile application, it should be appreciated that alternative methods of code development, such as alternative frameworks or writing code from scratch, could be used to implement identical form and function of the present invention.

The preferred embodiment of the present invention utilizes a unique gaming platform, integrating the use of content consumption followed by some sort of quiz or other questioning. The consumer is rewarded based on correct answers to the questions, to which the user may then redeem their rewards in the application to acquire products. Alternative embodiments may integrate various currencies, as well as additional content beyond videos. The unique features of the present invention allow for the mobile application to operate as a standalone system with limited access to creating and posting content, with only specific items available for reward redemption; or the system may integrate a more social media-like presence with a much more broad permission to create and post content, as well as the integration of the reward redemption system into a much larger e-commerce market.

While the preferred embodiment of the present invention is a mobile application with backend application support, it should be appreciated that the features present in the preferred embodiment may be integrated into a desktop application, virtual reality application, or other similar digital content application in alternative embodiments. Additionally, it should be appreciated that while the preferred embodiment includes digital content aimed at entertainment, alternative embodiments may include educational content in place of, or in addition to, the entertainment directed content.

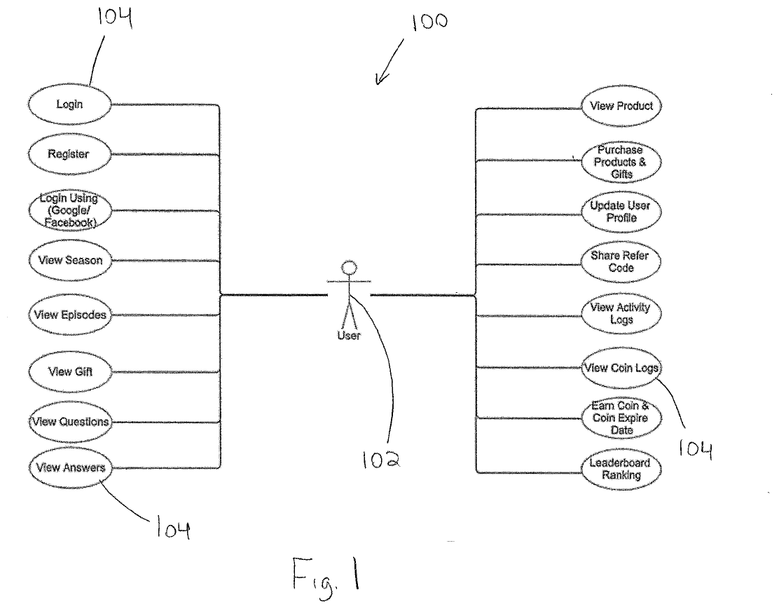

Referring now to FIG. 1 in the drawings, a unified modeling language diagram (UML Diagram) is illustrated according to a preferred embodiment of the present invention. UML Diagram 100 includes both a user 102 and functions 104. User 102 illustrates an example end user of the mobile application. Functions 104 are examples of selectable features within the application, such as an options to register/login, or to view certain pages of the mobile application once logged in. It should be appreciated that the mobile application may feature various additional functions 104, or it may remove some of the illustrated functions 104, while still maintaining the main form and function of the present invention.

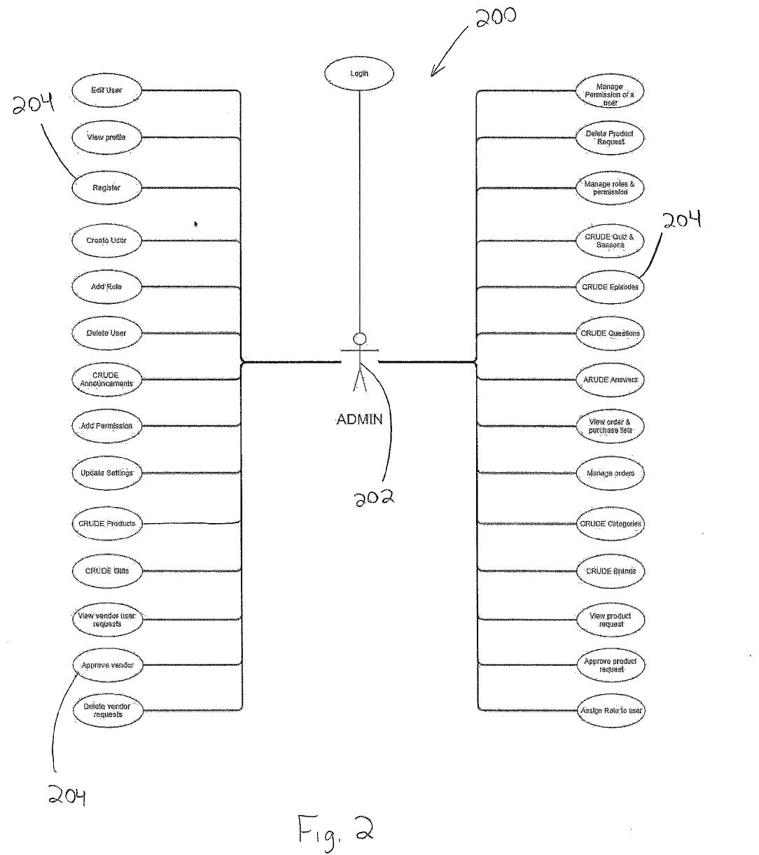

Referring now also to FIG. 2 in the drawings, a second UML Diagram is illustrated according to a preferred embodiment of the present invention. UML Diagram 200 includes the potential functions available to an administrator of the application through a back-end support application. Admin 202 is an example administrative user of the back-end support application, while functions 204 are illustrative of the functions available to admin 202 under the preferred embodiment of the present invention. Functions 204 include options to register, update settings, manage roles, and other various features. Similar to functions 104 of FIG. 1, it should be appreciated that functions 204 are illustrative of potential application features, but alternative embodiments may use fewer, additional, or alternative features while maintaining the desired form and function of the present invention.

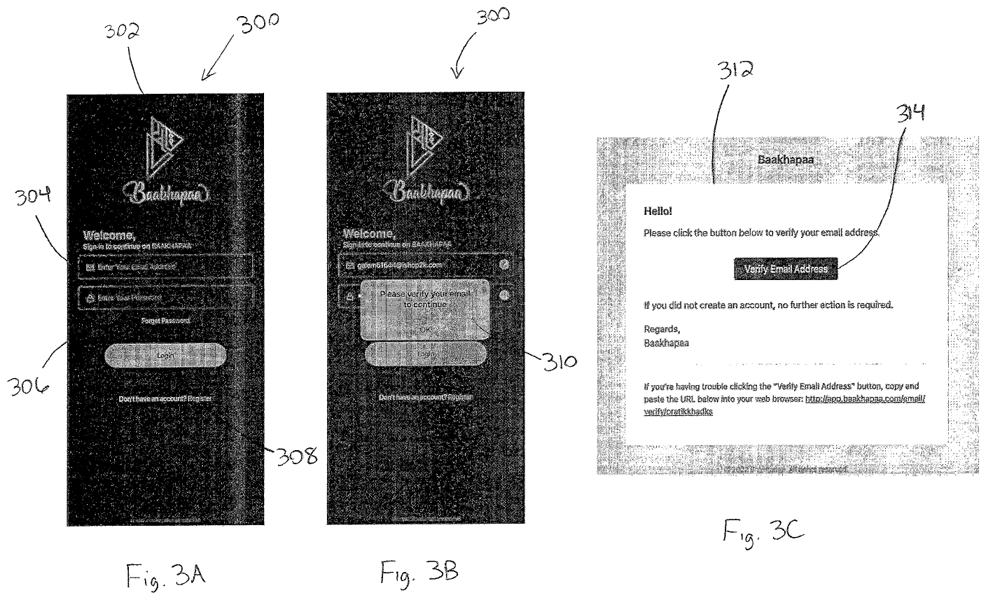

Referring now also to FIGS. 3A-3C in the drawings, several screenshots of the mobile application login process are illustrated. FIG. 3A best illustrates the login page 300 prior to any information being entered. Login page 300 preferably includes logo 302, information box 304, password recovery 306, and registration button 308. Under the preferred embodiment, logo 302 is a Baakhapaa logo, representing the title of the mobile application. It should be appreciated that alternative embodiments of the present invention may take on different names, which would likely result in a different logo in place of logo 302. Further embodiments may also remove the logo 302 entirely from the login page 300. Information box 304 preferably includes fillable boxes for standard login information, such as an email address and a password. It should be appreciated that alternative embodiments of the present invention may include alternative login information or alternative login methods. For example, a username could take the place of an email address, or a facial recognition feature could take the place of entering login information. Login page 300 also preferably includes links to other pages for retrieving a password or registering an account rather than logging in. Password recovery 306 preferably links to an alternative page where a user can request a new password if they have forgotten their login information. Registration button 308 preferably links to a new page where a user can sign up for a new account.

FIG. 3B best illustrates the login page 300 after user information has been entered to login for the first time. Upon first login under the preferred embodiment of the present invention, a user is prompted to verify their email address. This is illustrated with verification pop-up 310. A user will be able to verify their email address through an email screen 312, illustrated in FIG. 3C. Once a user presses verification button 314, their account will have been verified and they will be able to proceed beyond login page 300 and further into the mobile application. It should be appreciated that login page 300 and email 312 may take on various appearances not illustrated in this application while maintaining the functionality of the present invention.

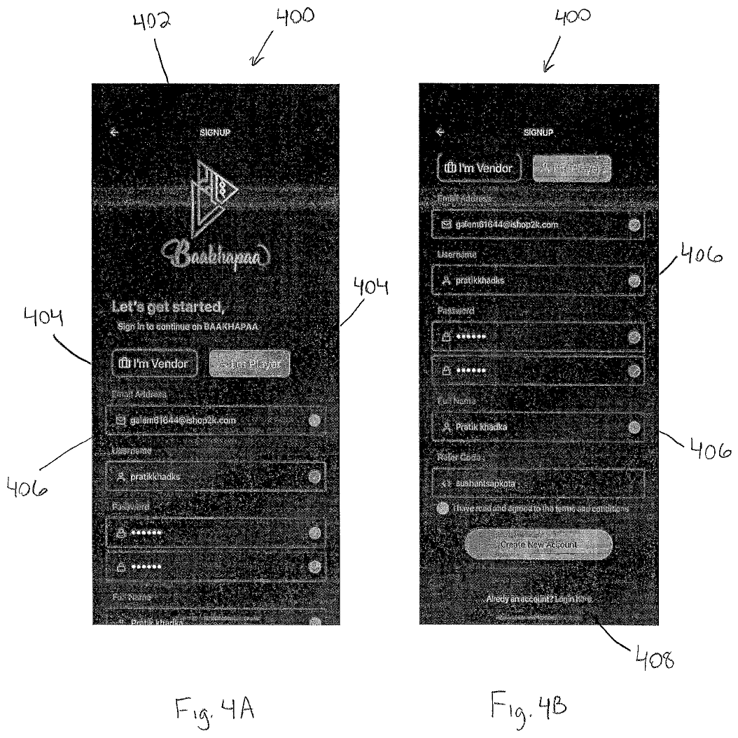

Referring now also to FIGS. 4A-4B in the drawings, screenshots of a registration page for the mobile application are illustrated according to a preferred embodiment of the present invention. Both FIG. 4A and FIG. 4B best illustrate the fillable information fields for registration according to a preferred embodiment of the present invention. Registration page 400 preferably includes logo 402, identification selection tab 404, information boxes 406, and login redirect 408.

Logo 402 is similar to logo 302, and it should be appreciated that alternative embodiments may contain variations of logos or even no logo at all. Identification selection tab 404 serves to function as an indicator of whether a new user would like to register as a product vendor, or as a player. It should be appreciated that identification selection tabs 404 may use various terms for the users other than vendor and player in alternative embodiments, while still maintaining the desired functionality of the present invention. Further, additional options may be present in alternative embodiments, such that more than two identification selection tabs 404 are necessary. Information boxes are shown to include options such as email address, username, password, name, and referral code. However, it should be appreciated that alternative embodiments may require further information. Login redirect 408 is preferably a link that would take a user to login page 300 so that an already existing user may login, rather than register a new account.

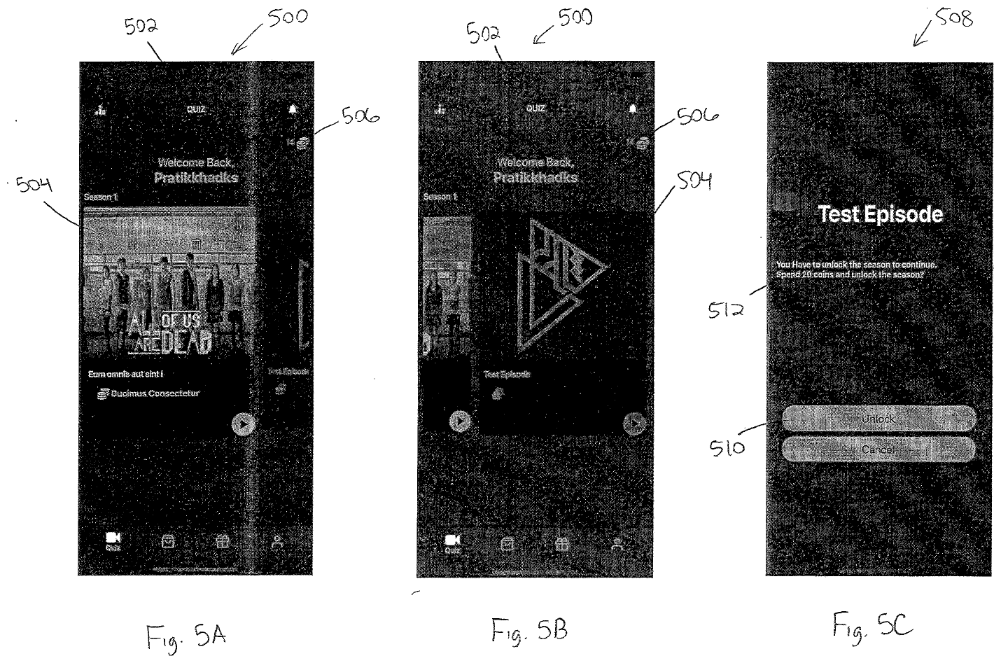

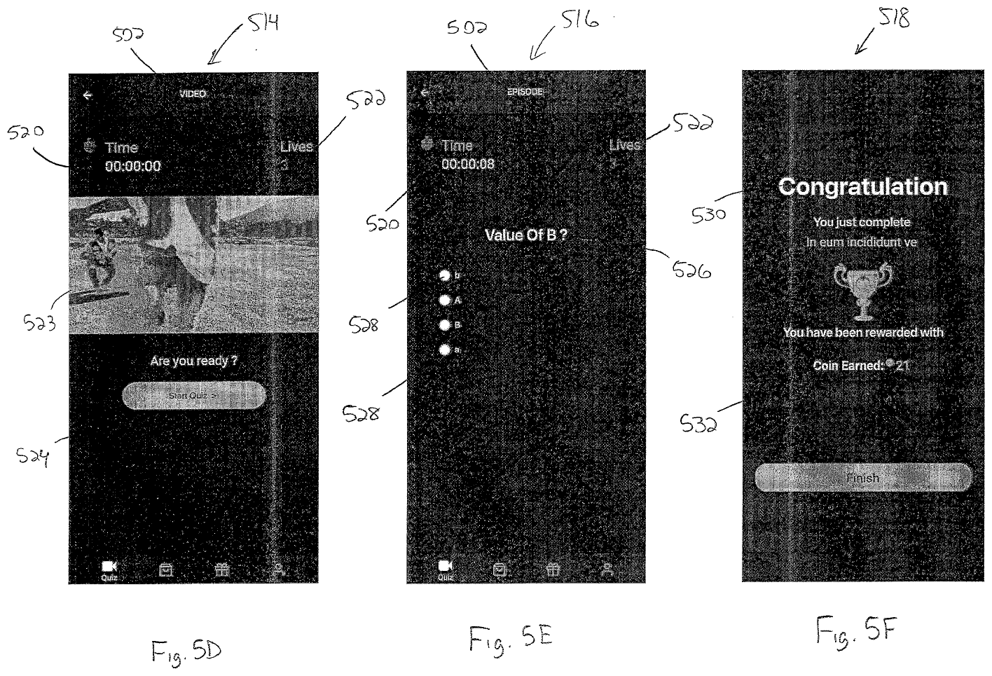

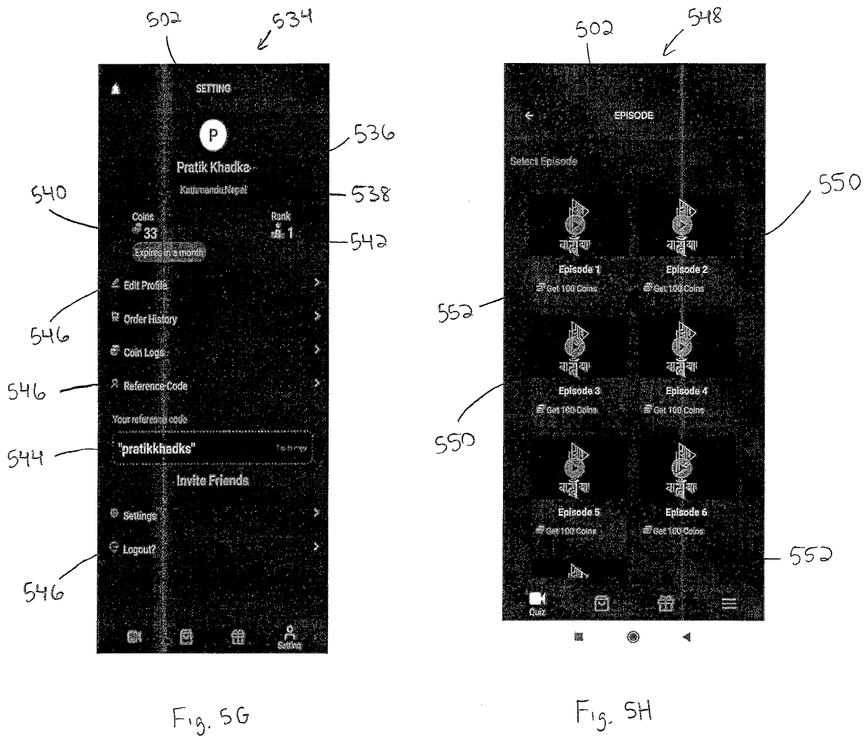

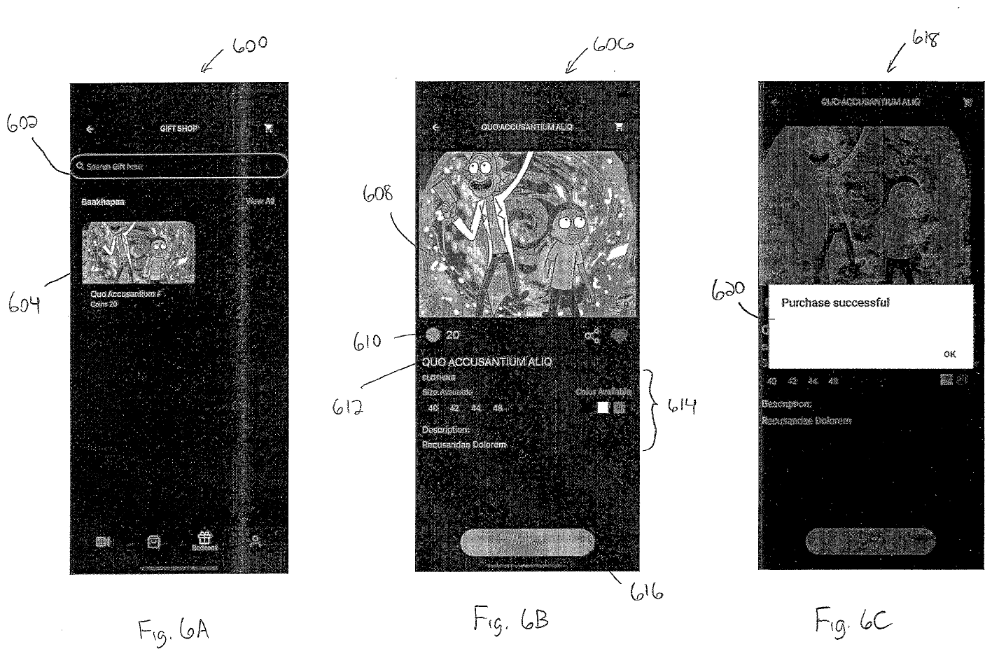

Referring now also to FIGS. 5A-5H in the drawings, various screenshots of a quiz-taking feature are illustrated. Under the preferred embodiment, a user will be able to play a quiz game in order to earn currency within the mobile application. The quiz-taking feature preferably begins with a quiz screen 500, best illustrated in FIGS. 5A and 5B.

The quiz screen 500 preferably includes page indicator 502, season selection 504, and currency counter 506. Page indicator 502 preferably changes when moving to a screen with a different description, such as “video” or “episode” as illustrated in FIGS. 5D and 5E. Season selection 504 will preferably vary in its appearance as new seasons become available or old seasons are removed from the mobile application. AS illustrated in FIGS. 5A and 5B, several example seasons are shown including “Test Episode.” Currency counter 506 preferably displays the current value of the user's in-application currency, which may be used for a variety of features. These features may include, but are not limited to, unlocking future seasons of a show, unlocking new rewards, or buying products and gifts from the marketplace. It should be appreciated that alternative embodiments of the present invention may have different logos for currency, or may display a currency in an alternative way, without deviating from the functionality of the present invention. FIG. 5C best illustrates a screenshot of the next page when a user would click on “Test Episode” of FIG. 5B. In the embodiment of FIG. 5C, a user is presented the option of unlocking a new season of “Test Episode” for 20 coins. It should be appreciated that this screenshot is illustrative, and alternative embodiments of the present invention will include various shows to unlock at varying costs. Episode unlock page 508 includes a description 512 of the user selection, as well as an unlock/cancel selection 510. A user preferably will have the option to proceed with spending currency to unlock a new season or to cancel and return to the previous page.

When a user selects an unlocked episode from the episode screen 548 (described below), the user is preferably redirected to video screen 514. Video screen 514 preferably includes timer 520, life counter 522, video 523, and quiz button 524. Under the preferred embodiment, video 523 will begin playing on video screen 514, the video 523 being any kind of episode, advertisement, or other type of video. It should be appreciated that alternative embodiments of the present invention may include other information on video screen 514, such as advertisements, links to other seasons, links to gifts/products, or other similar information.

Under the preferred embodiment, the quiz button 524 is present during the entire playing of video 523. However, the quiz button 524 may be “locked” until the entire video is played, or the quiz button 524 could be pressed at any time during video 523. Once quiz button 524 is pressed, a user is preferably redirected to quiz screen 516. Quiz screen 516 is preferably a multiple choice question screen including timer 520, life counter 522, quiz question 526, and answer selections 528. It should be appreciated that FIG. 5E is illustrative, and that the questions and answer selections will vary, depending on the video that was viewed on the previous screen. It should further be appreciated that, in alternative embodiments, other quiz formats may be used besides multiple choice. For example, a quiz may be fill in the blank format, true/false format, or any other reasonable standard quiz format. Under the preferred embodiment, a user answer that is correct will redirect the user to either the next question of the quiz, or to a finish screen if there are no more questions to answer. However, if a user incorrectly answers, they will have another opportunity to answer, so long as they had lives remaining in the life counter 522. The life counter is preferably reduced by one for every incorrect answer. If the life counter has been reduced to zero, a user will be redirected to a page to show that they have failed the quiz. After failure of a quiz, a user will preferably be able to re-watch the video and re-take the quiz if desired. It should be appreciated that time limits and life limits may vary in alternative embodiments of the present invention.

FIG. 5F best illustrates a finish screen 518, which shows a user a message 530 that they have successfully completed a quiz and have earned a currency reward 532. The currency reward 532 preferably varies based on the video watched and the questions answered. In alternative embodiments of the present invention, a currency reward may vary in amount based on the percentage correct on the quiz, or the amount of tries it took to complete the quiz.

FIG. 5G best illustrates a user profile screen with user information and links to other areas of the mobile application. User screen 534 preferably includes name 536, location 538, currency counter 540, leaderboard rank 542, reference code 544, and links 546. Under the preferred embodiment, a user's name 536 and location 538 are displayed to the individual user. However, these may be hidden to other users depending on privacy settings in alternative embodiments that may contain methods of connecting with other people. Related to other users, the reference code 544 can be used to send others a link to sign up and earn a referral bonus. The referral bonus may vary depending on the embodiment, but may include benefits such as a currency reward, a free episode unlock, or other various bonuses. There may be a limit on such referral bonuses in alternative embodiments of the present invention. It should be noted that currency counter 540 includes coins with an expiration date. The expiration date preferably varies based on when the coins were added or spent. Under the preferred embodiment, the length of time before expiration of these coins varies depending on the admin input from the backend (described below).

Under the preferred embodiment, a user's statistics are tracked and allocated to a leaderboard position, illustrated with leaderboard rank 542. Such statistics may include information such as episodes watched, currency earned, or other similar user statistics. Links 546 may vary, but under the preferred embodiment, include the ability to edit the user's profile, the user's order history, coin logs, reference codes, settings, and the option to log out of the user account. It should be appreciated that alternative embodiments may include fewer link options or additional link options not currently illustrated in FIG. 5G.

FIG. 5H best illustrates an episode screen that will be available within a season according to the preferred embodiment of the present invention. When a season 504 is selected from FIGS. 5A-5B, a user will preferably be presented with episode screen 548. Episode screen 548 preferably includes episodes 550 and rewards 552. It should be appreciated that alternative seasons may have variances in the number of episodes 550 available and the rewards 552 that are earned with each episode. Additionally, it should be appreciated that the rewards shown in FIG. 5H may vary per episode, with different episodes 550 having different rewards 552 within the same season.

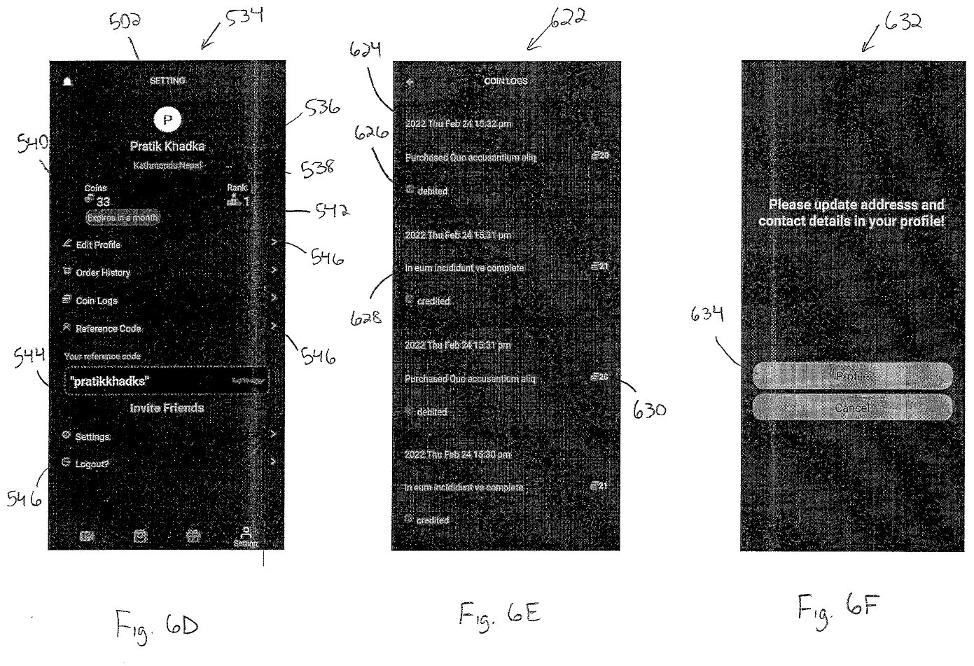

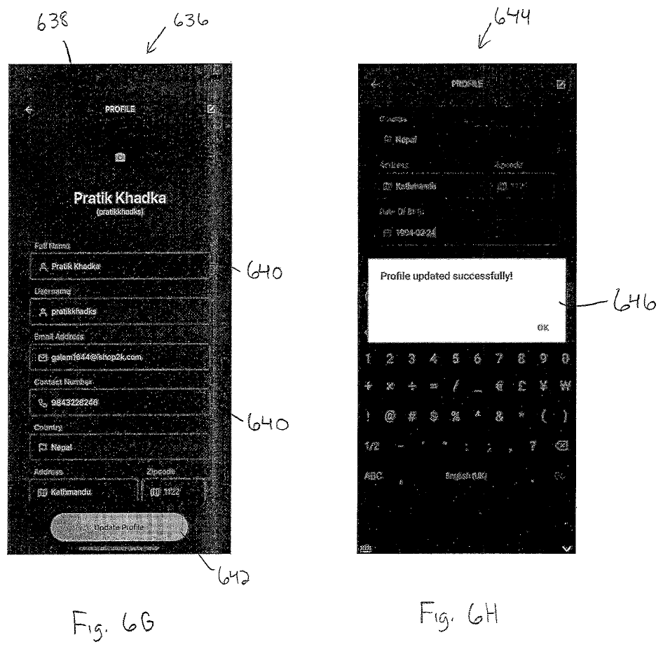

Referring now also to FIGS. 6A-6E in the drawings, various screenshots associated with the mobile application gift shop are illustrated. FIG. 6A is a gift shop screen 600, according to a preferred embodiment of the present invention. Gift shop screen 600 preferably includes search bar 602 and item link 604. It should be appreciated that the embodiment illustrated in FIG. 6A is illustrative, and that alternative embodiments may include additional or alternative item links 604, such that a user has additional options to choose from on gift shop screen 600. Search bar 602 is preferably configured such that a user may type in the title of a desired item link 604 and is then taken to that item link, rather than scrolling through the entire gift shop screen.

FIG. 6B best illustrates the item screen that a user would see after clicking on an item link 604 from the gift shop screen 600. Item page 606 preferably includes image 608, price 610, title 612, item information 614, and purchase button 616. Image 608 preferably includes a visual depiction of the item, such that a user has a better understanding of what the item may look like. It should be appreciated that this image 608 will vary for each item available. Title 612 is preferably the title of the item and price 610 is preferably the value of currency that a user needs to exchange in order to receive the item selected. Under the preferred embodiment, the reward coins earned as in-app currency are used for these item purchases. However, it should be appreciated that alternative embodiments may provide the user with various currency options to use. Item information 614 preferably includes a description of the category for the item, such as clothing in FIG. 6B, as well as other information that may be needed. In the case of clothing, size and color are options to select within item information 614. It should be appreciated that alternative item categories may not require a size and color selection, and some items may require additional information to be selected.

When a user has the desired item selected and the proper information selected, a user will have the option to press the purchase button 616. If a user has made all selections required and has at least the required amount of currency in their account, purchase confirmation screen 618 will appear. The user's purchase is then confirmed and message 620 appears to alert the user that their purchase has been successful. It should be appreciated that alternative messages 620 may appear if the purchase was unsuccessful, such as the user not having the required amount of currency in their account to make the purchase.

FIG. 6D is identical to FIG. 5G, as further illustration that a user may select the link 546 that shows “coin logs” in order to access the coin logs page 622, best illustrated in FIG. 6E. Coin logs page 622 preferably includes log time 624, log type 626, log description 628, and log amount 630. Log time 624 preferably displays the exact date and time that a user transaction occurred, such as a reward being earned or an item being purchased. Log description 628 preferably illustrates the item or reward that the transaction was for. Log type 626 is preferably either a display of debit or credit, properly included when a user either earns currency or spends currency. Finally, the log amount 630 preferably displays the number of currency either flowing in or out of the user's account. It should be appreciated that alternative embodiments of the present invention may include additional items in the coin log, such as a transfer of coins from one user to another or a withdrawal/deposit of currency.

Referring now also to FIGS. 6F-6H in the drawings, a sequence of profile update screens are illustrated. Under the preferred embodiment of the present invention, a user may occasionally be asked to update their profile. This update notice 632 may occur when a user needs to include additional information in order to complete a transaction, such as a shipping address when purchasing an item. Update notice 632 will include selection 634 for a user to either update their profile or cancel the previous request.

Profile update screen 636 is best illustrated in FIG. 6G. From profile update screen 636, a user may preferably choose to upload photo 638, edit information boxes 640, and finally confirm updates with update button 642. When a user fully completes desired updates and selects the update button 642, the user is preferably redirected to update confirmation screen 644, best illustrated in FIG. 6H. Update confirmation screen 644 preferably includes message 646. Message 646 will preferably include a statement confirming the profile update if the update was successful, but may include statements about an error or some other issue with the update, which may then prompt the user to again attempt to update their profile or to move on without the update.

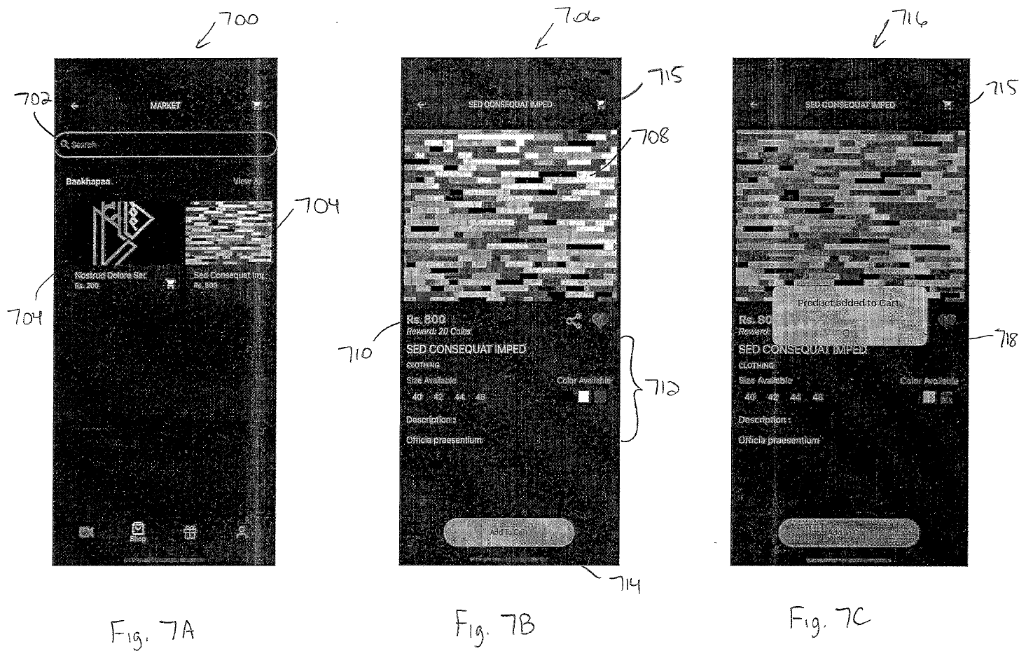

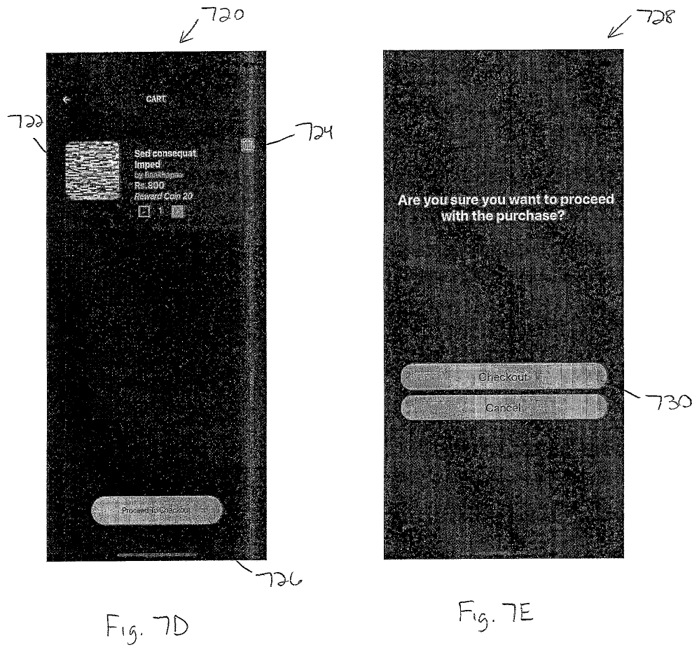

Referring now also to FIGS. 7A-7E in the drawings, various screenshots of the product purchase process in the mobile application for streaming video are illustrated. FIG. 7A best illustrates market screen 700, including a search bar 702 and two products 704. It should be appreciated that alternative embodiments of the present invention may include any number of products in addition to, or in place of, the products 704 illustrated in FIG. 7A.

FIG. 7B best illustrates an individual product screen after accessing through the product market of the mobile application for streaming video. Under the preferred embodiment, a user is presented with product screen 706 after clicking on a product 704 from market screen 700. Product screen 706 preferably includes image 708, price 710, product information 712, and cart buttons 714/715. Image 708 preferably provides the user with a preview of the product, such that a user has a better idea of whether to purchase the product or not. Such previews could include, but are not limited to, an actual image of a good, a pattern for clothing, a design/material for a decorative item, or other similar products. It should be appreciated that there is no limit to the items that could be displayed in the product market, subject to the discretion of the vendors and admin members of the mobile application.

Price 710 is illustrative for purposes of providing an example display of the value of a product. However, it should be appreciated that alternative embodiments may include various currencies and values. For example, price 710 displays the cost of an item as 800 Nepalese Rupees (Rs.), but could include other currencies such as U.S. Dollars, various forms of crypto currency, or any other form of currency. Additionally, price 710 preferably includes a reward value, given in coins, which a user may be provided when purchasing the product. When using the mobile application for streaming video of the present application, a user is rewarded with in-application currency (coins in the preferred embodiment) for purchasing products within the mobile application. It should be appreciated that alternative rewards/reward amounts may be present for products in alternative embodiments of the present application, including the possibility that some products may not have any reward included.

Product information 712 is preferably similar to item information 614, which is described above. Product information 712 preferably includes a description of the category for the item, such as clothing in FIG. 7B, as well as other information that may be needed. In the case of clothing, size and color are options to select within product information 712. It should be appreciated that alternative item categories may not require a size and color selection, and some items may require additional information to be selected. Once a user is satisfied with their selection for a product, they may then press the cart button 714 to add the item to their cart and move forward with the product purchase process. Although a user will preferably not be directed to their cart immediately after engagement of cart button 714, the user may be presented with an option to go to cart or to remain in the market. Further, if remaining in the market, a user may engage cart button 715 to be taken to their cart, where they may see any items that are currently being stored in their cart.

FIG. 7C best illustrates a confirmation screen presented to a user after adding a product to their cart. Confirmation screen 716 preferably includes a message 718. Message 718 preferably contains language alerting the user that a product has been added to their cart, and an option for the user to close the message or advance past the message. As illustrated in FIG. 7C, the option only includes an “ok” button to close the message. However, it should be appreciated that alternative embodiments may present the user with additional options, such as “go to cart” or “cancel cart addition.”

FIG. 7D best illustrates a user's cart screen within the mobile application for streaming video of the present application. Cart screen 720 preferably includes products 722, removal button 724, and checkout button 726. Products 722 preferably include any number of products that a user has added to their cart via the previous screens illustrated. A user may have no items in their cart or they may store items that they intend to purchase eventually in their cart. It should be appreciated that products may vary in availability while a user has the product in their cart, and it is not a guarantee that the product will be available upon checkout. Additionally, the products 722 preferably have an option to select the quantity of that product that a user desires to purchase. Removal button 724 preferably removes the selected product from a user's cart when the removal button 724 is engaged by the user. Finally, checkout button 726 is configured such that a user will be redirected to a checkout screen for the products included in the user's cart when the user engages the checkout button 726.

FIG. 7E best illustrates the final purchase verification screen presented to a user. Under the preferred embodiment, a user will be presented with purchase verification screen 728 after selecting proceed to checkout from the cart screen 720. Purchase verification screen 728 preferably includes selections 730. Selections 730 preferably includes options for a user to either confirm a purchase and checkout, or to cancel the purchase and be redirected back to the prior screen. It should be appreciated that these selections may vary in size, shape, and language, while still maintaining the functionality of the present invention. Under the preferred embodiment, a user may have their profile setting set to purchases being “payment on delivery.” If that is the setting selected, a user will not enter any payment information at the time of checkout, but rather pay at the time of delivery. It should be appreciated that alternative embodiments of the present invention may vary in payment methods, such as possibly requiring credit card at the time of the purchase.

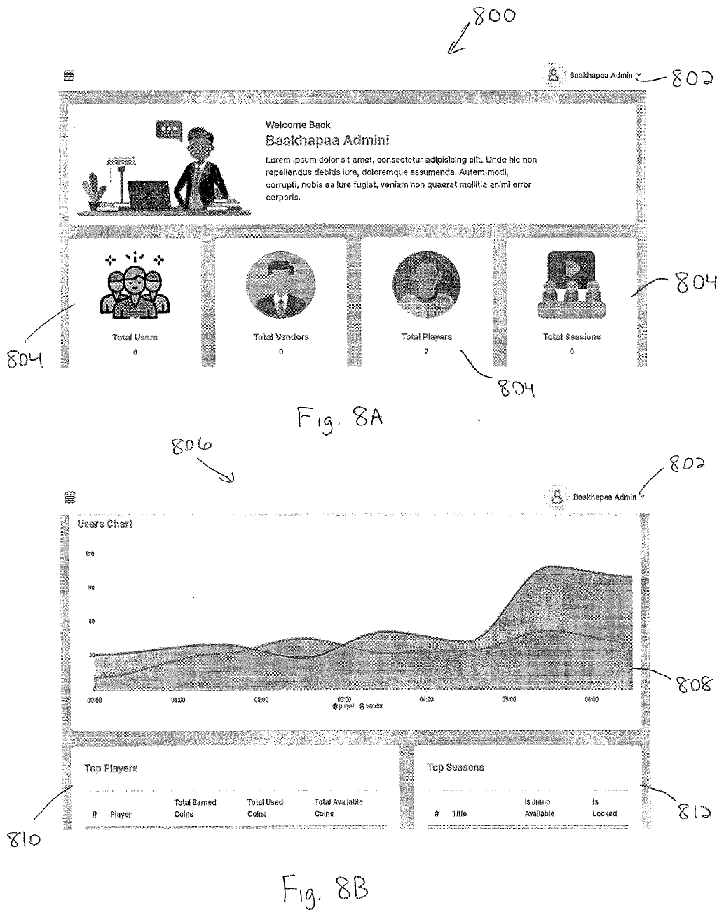

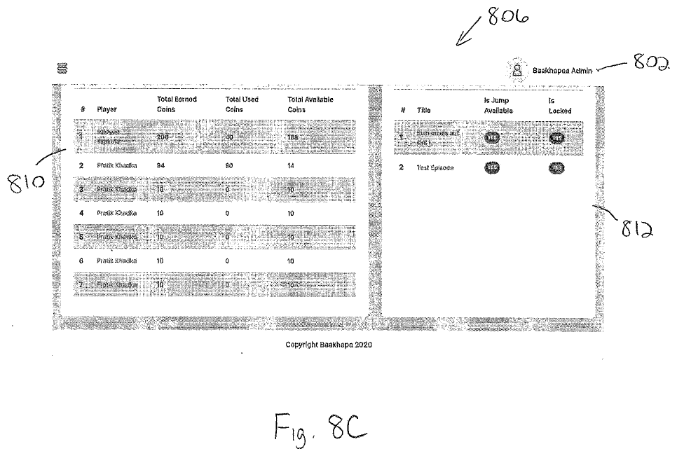

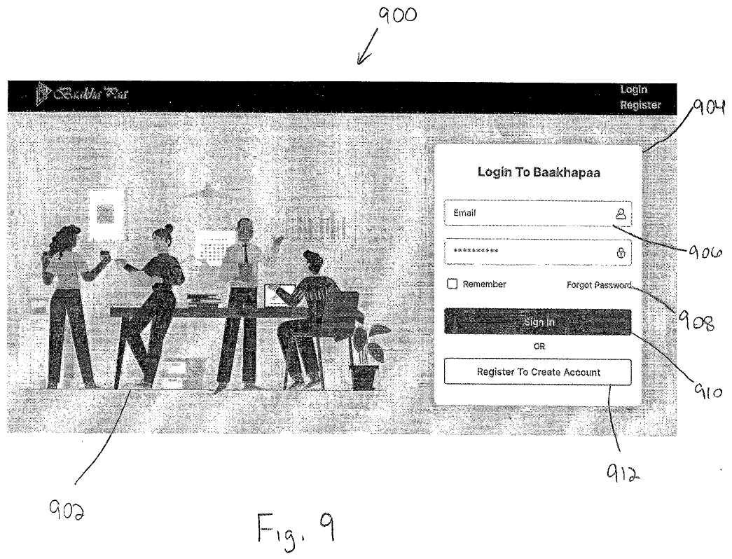

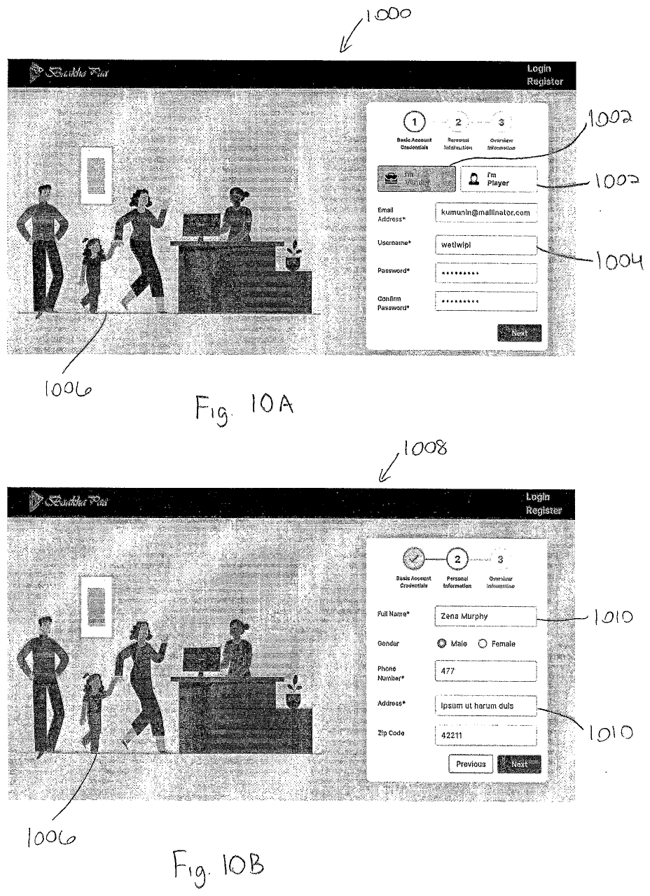

Referring now also to FIGS. 8A-8C in the drawings, an admin page of the backend application for the mobile application for streaming video is illustrated according to a preferred embodiment of the present invention. FIG. 8A best illustrates the main admin dashboard page following login to the backend application. Admin dashboard 800 preferably includes account 802 and information tabs 804. Account 802 preferably displays the user that is currently logged in (if any), and a drop down arrow to allow a user to access additional links related to their account, such as account settings and a log out option. If no user is logged in, account 802 may show a login/register option in place of the account name. Information tabs 804 preferably include links to various information, such as number of users on the mobile application, number of vendors on the mobile application, total mobile application players, and total video sessions played. It should be appreciated that alternative data and analytics, as well as other mobile application user information may be present on admin dashboard 800 in alternative embodiments of the present invention.

FIGS. 8B and 8C best illustrate a detailed view of user data presented within the backend application of the present invention. Under the preferred embodiment, data screen 806 includes account 802, user chart 808, player list 810, and season list 812. User chart 808 preferably includes a visual display of data such as the chart in FIG. 8B, which indicates the number of users on the mobile application over a certain period of time. Player list 810 preferably includes a graphic of the top players, ranked by a metric such as total coins earned within the mobile application. Player list 810 preferably further includes user data such as total coins spent and total coins currently available. It should be appreciated that additional or alternative user metrics may be used to sort the list of “top players.” Season list 812 preferably includes a graphic of the top seasons, ranked by a metric such as total views. Under alternative embodiments, season list may include rankings and metrics for alternative data such as individual episodes or entire shows, rather than single seasons. It should be appreciated that alternative embodiments of the present invention may include a variance in metrics collected and how they are displayed to the backend application admin, for all of the user and season information as described above.

Referring now also to FIG. 9 in the drawings, a login page of the backend application is illustrated according to a preferred embodiment of the present invention. Login screen 900 preferably includes graphic 902 and login box 904. While graphic 902 is illustrated as group of people socializing and working around a table with various background elements, it should be appreciated that alternative embodiments of the present invention may include a variety of graphics, including a simple logo or other graphic with or without people in it. Login box 904 preferably includes information boxes 906, password recovery 908, sign in tab 910, and registration tab 912. Under the preferred embodiment, information boxes 906 are fillable boxes where a user may enter their email and associated password in order to login to an already existing mobile application account. Alternative embodiments of the present application may include alternative login methods, such as a username in place of email or biometric related logins, such as a fingerprint login or face scan. It should be appreciated that the examples provided here are merely illustrative and not limiting, and that alternative embodiments may utilize many additional login methods not listed herein. Sign in tab 910 preferably enables a user to move on from login screen 900 and into the backend application when the user credentials are verified. Additionally, if the user credentials are not associated with an existing account, a message (not shown) may be displayed alerting the user of the login error. Registration tab 912 preferably redirects the user to a new registration page when the user engages the tab. Alternative embodiments may include a drop down tab, rather than redirecting the user to a new page.

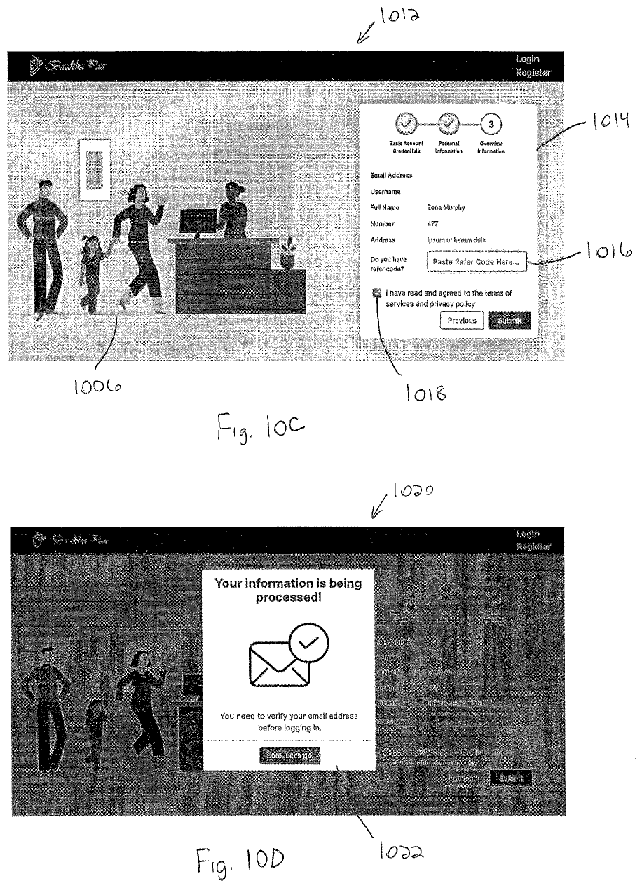

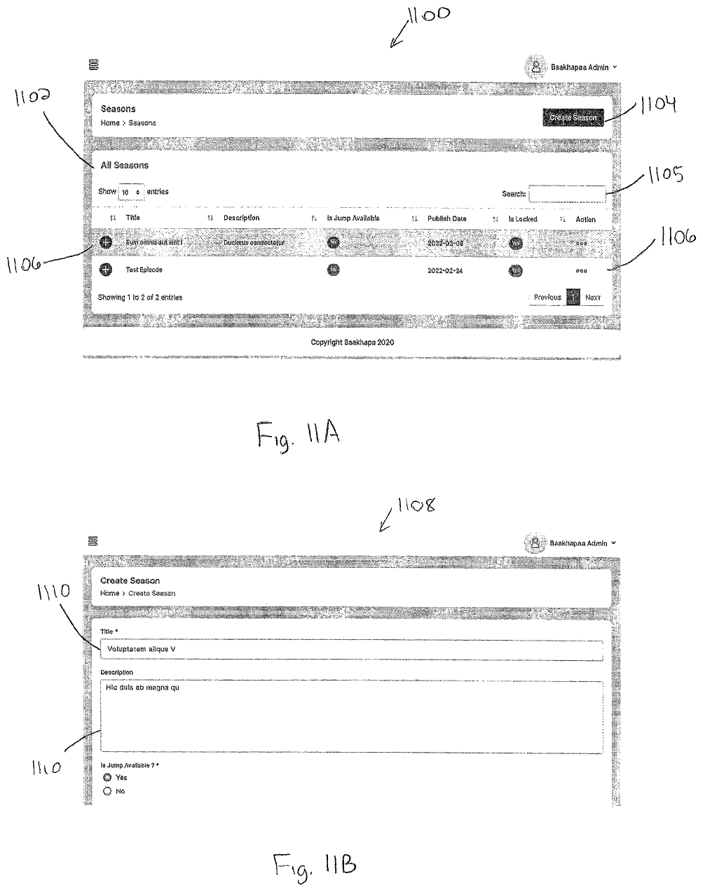

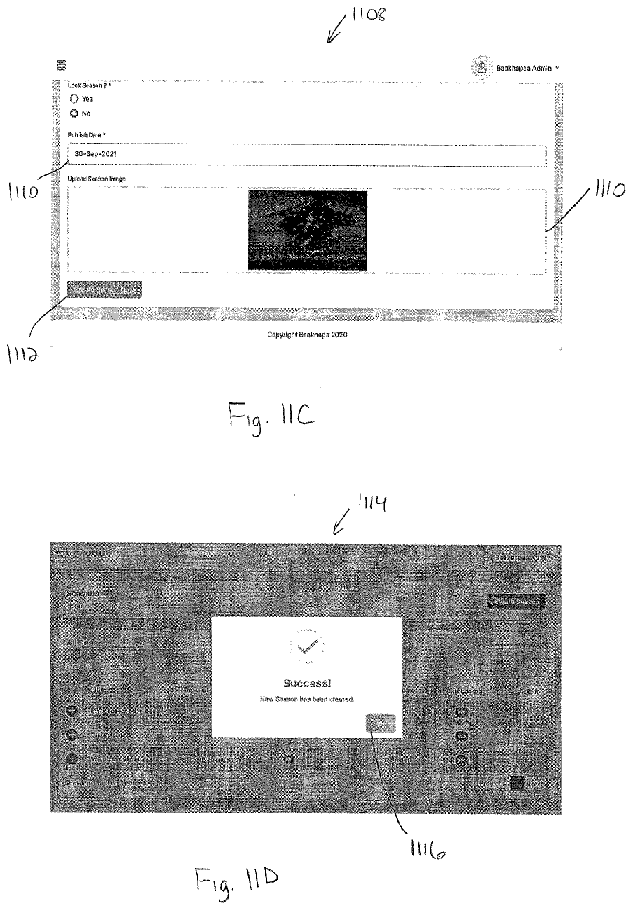

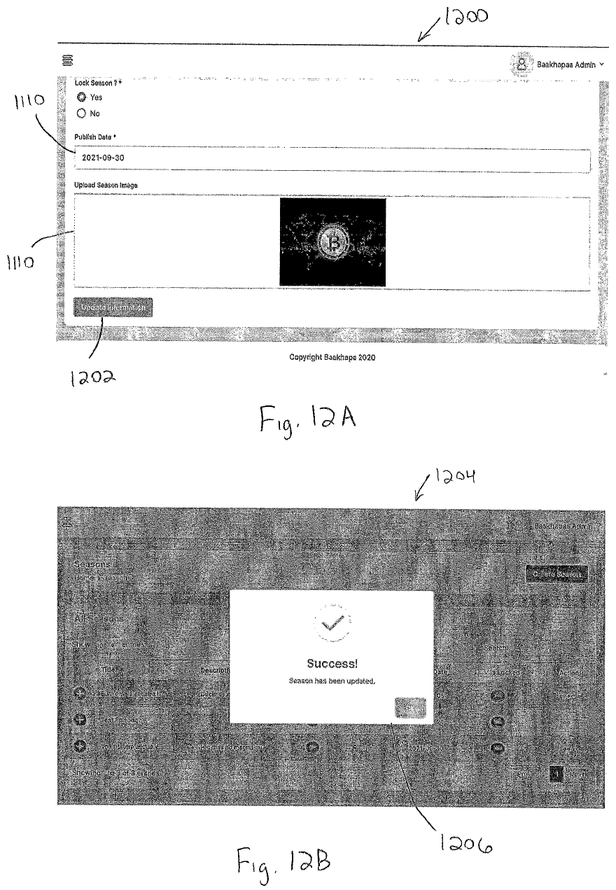

Referring now also to FIGS. 10A-10D in the drawings, various screenshots of a backend application vendor registration process are illustrated. Registration page 1000 preferably includes account type selection 1002, information boxes 1004, and graphic 1006. FIG. 10A best illustrates these preferred elements being part of a basic account credential page. Account type selection 1002 preferably includes an option for a user to select between creating a vendor account or a player account. Under the preferred embodiment, a vendor account is used for businesses looking to have their products sold on the mobile application or looking to have created content viewable to users of the mobile application, whereas a player account is used solely for the purpose of viewing content and viewing/purchasing products. Information boxes 1004 preferably include user fillable boxes for information such as an email address, user name, and password that the registering user wishes to have associated with their account.

FIG. 10B best illustrates the personal information portion of the registration process. Registration page 1008 preferably includes graphic 1006 and information boxes 1010. As illustrated, graphic 1006 is identical to the graphic 1006 in FIG. 10A, although it should be appreciated that alternative embodiments of the present invention may use alternative graphics on every page, or even may have different graphics being cycled on the same page. Information boxes 1010 are similar to information boxes 1004, but under the preferred embodiment request different information, such as name, gender, phone number, and address.

FIG. 10C best illustrates an information overview page, prior to the user committing their information for registration. Under the preferred embodiment, overview screen 1012 includes a list of the information entered by the user on registration pages 1000/1008, such that a user may verify that the information they entered is correct. Overview box 1014 is where this information is all displayed, while also including referral entry 1016 and agreement 1018. Referral entry 1016 preferably allows a user to enter a code received from another existing user, such that either user may be provided with a reward of some kind for using the referral system. It should be appreciated that the referral bonus may vary and is subject to the terms of the mobile application. Agreement 1018 may provide a link for a user to view the terms of service and privacy policy, which the user must agree to prior to registering their account. It should be appreciated that the information entered and displayed on registration pages 1000/1008 and overview screen 1012 may be combined into one screen in alternative embodiments, or those pages may require alternative or additional information.

FIG. 10D best illustrates a confirmation screen 1020 that preferably appears after a user submits their registration information. Under the preferred embodiment, a user will be presented with message box 1022, alerting them for the need to verify their account registration through email. It should be appreciated that alternative embodiments of the present invention may include various verification options, such as verifying by phone number.

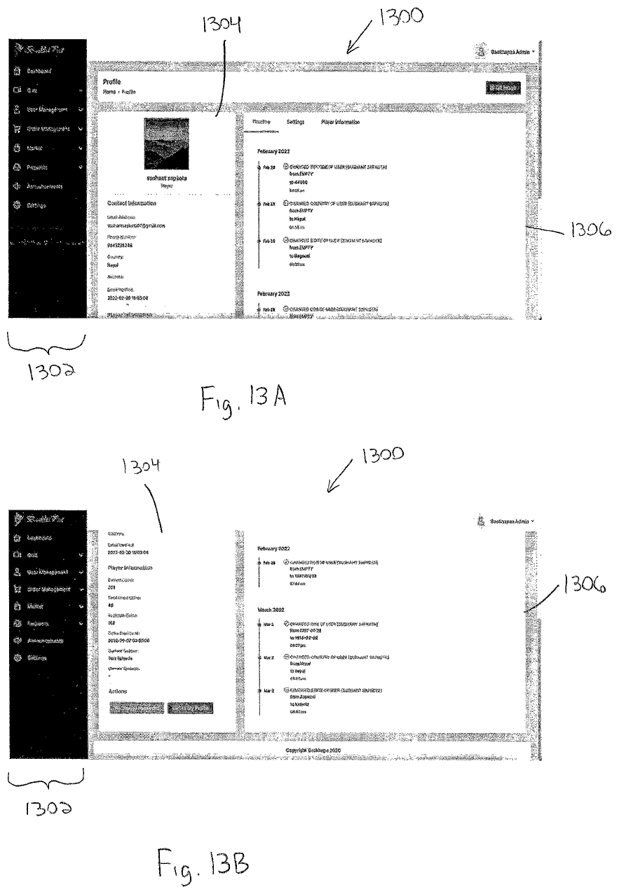

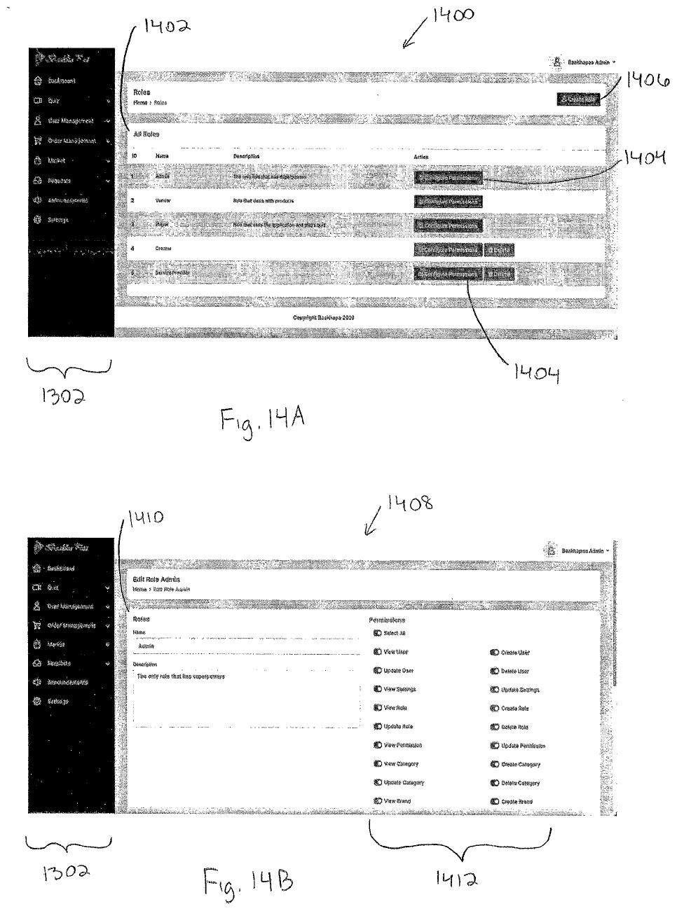

Referring now also to FIGS. 11A-11D in the drawings, various screenshots of the season overview and creation pages are illustrated. FIG. 11A best illustrates a season dashboard screen. Season dashboard 1100 preferably includes season list 1102 and creation button 1104. Season list 1102 preferably includes a number of seasons 1106 and the associated information with them, as well as search bar 1105. Under the preferred embodiment, a user may search for a key term or for a full season title to find that season 1106, rather than scrolling through the full season list 1102. It should be appreciated that alternative embodiments may allow for users to utilize the search bar 1105 by searching for other various terms, such as a specific creator, description, or release date, among other options. Seasons 1106 preferably include information about each season, such as title, description, date published, jump status, lock status, and any associated actions.

FIGS. 11B and 11C best illustrates the page presented to a user when creating a new season under the preferred embodiment. Season creation page 1108 preferably includes season information 1110 and confirm button 1112. Under the preferred embodiment of the present invention, season information includes title, description, jump, lock, date, and image. The creator preferably has the option to enter this information in whatever manner desired, and then confirm season creation with the confirm button 1112. Preferably, locking a season will set whether a user has to pay to unlock the season or if it is available to everyone, and the jump setting will determine if a user may skip episodes/seasons. If the jump feature is available, a user preferably may elect to skip a season and move on to the next at no cost. When the jump feature is disabled, a user preferably has to pay an additional amount of coins, or other currency, in order to skip a season. It should be appreciated that alternative, additional, or fewer options and settings may be available to the creator of a new season in alternative embodiments of the present invention. FIG. 11D best illustrates the confirmation message presented to a user when a new season has been created. Confirmation screen 1114 includes message 1116, which preferably confirms to the user that the season was created. It should be appreciated that alternative messages may appear to the user in alternative embodiments, such as an error message or an option for the user to proceed to a different screen.

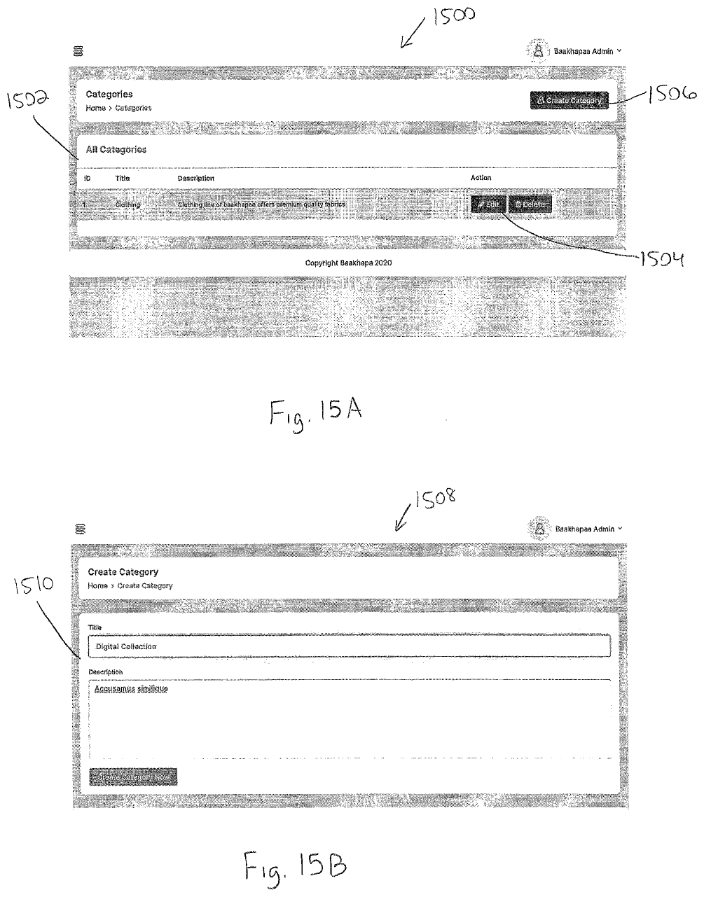

Referring now also to FIGS. 12A-12B in the drawings, the preferred embodiment of the season editing screen is illustrated. Season editing screen 1200 is preferably similar to season creation page 1108, including season information 1110. However, as seen between FIG. 12A and FIG. 11C, the season image has been changed as an example of the edits that can be made within season editing screen 1200. When a user is satisfied with the edits made, they may engage update button 1202, such that the edits are confirmed and saved. FIG. 12B best illustrates the confirmation message that a user will see after successfully updating season. Confirmation screen 1204 preferably includes message 1206, which may alert the user as to the status of their updates. Included in this message 1206 could be a success message as illustrated in FIG. 12B or could be an error message or similar message if something went wrong with the update. It should be appreciated that the format and view of this message may vary in alternative embodiments of the present invention while maintaining the desired function.

Referring now also to FIGS. 13A-13B in the drawings, an example admin profile in a preferred embodiment of the present invention is illustrated. Profile screen 1300 preferably includes selection tab 1302, user profile box 1304, and activity timeline 1306. Under the preferred embodiment, selection tab 1302 includes various options for the user to navigate the application, such as links to the dashboard, quizzes, user and order management, the market, requests, announcements, and settings. It should be appreciated that alternative embodiments of the present invention may include additional, fewer, or alternative options associated with the selection tab 1302.

Under the preferred embodiment, user profile box 1304 includes user information such as name, contact information, and location, as well as account information such as currency counter and related data. It should be appreciated that alternative embodiments of the present invention may include varying information within the user profile box 1304. Activity timeline 1306 preferably includes information about activity that the user has recently undertaken within the application, such as various modifications to the user's profile.

Referring now also to FIGS. 14A-14B in the drawings, various screens illustrating the roles and permissions views are shown. Under the preferred embodiment roles screen 1400 includes roles list 1402, editing options 1404, and creation button 1406. Roles list 1402 preferably includes information such as user IDs, names, and descriptions. It should be appreciated that alternative embodiments of the present invention may include various role information within the role list. Editing options 1404 preferably provide the user with the ability to either edit the roles or delete the role, although it should be appreciated that there may be additional editing options within roles screen 1400, such as assigning priorities to different roles within the list. Creation button 1406 preferably links the user to a new page for a new role creation when the user engages the button. FIG. 14B best illustrates role editing screen 1408, which preferably includes role description 1410 and permissions 1412. Under the preferred embodiment, role description 1410 includes a name and description of the role, however it should be appreciated that alternative embodiments may include additional information within this description. Preferably, permissions 1412 include a variety of selections available to the user, such as assigning various account abilities, such as permission to create, edit, or delete certain aspects within the present invention. It should be appreciated that alternative embodiments may include additional, fewer, or alternative permission selections.

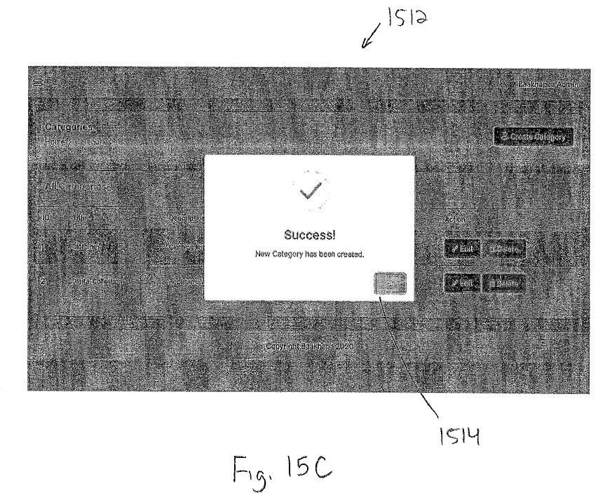

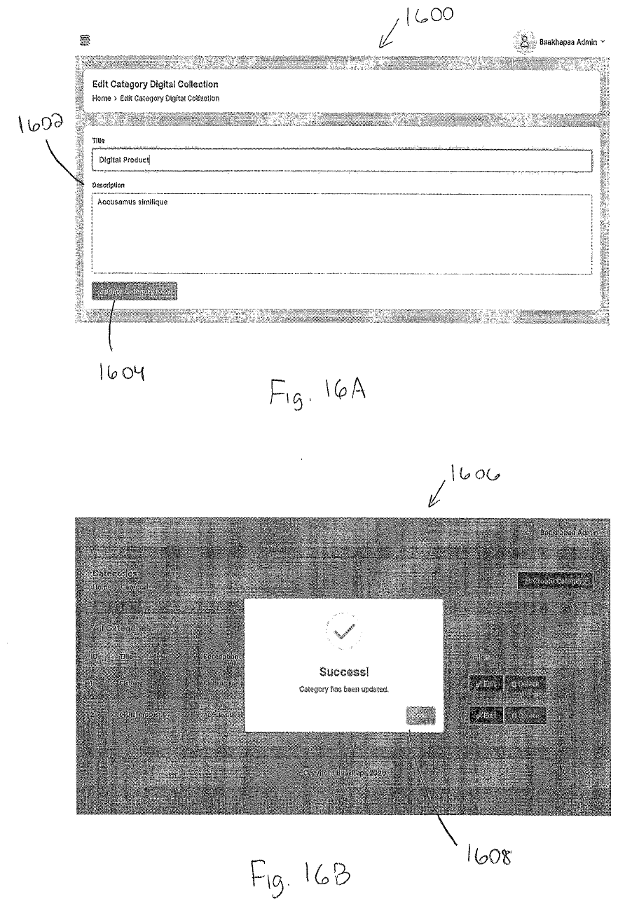

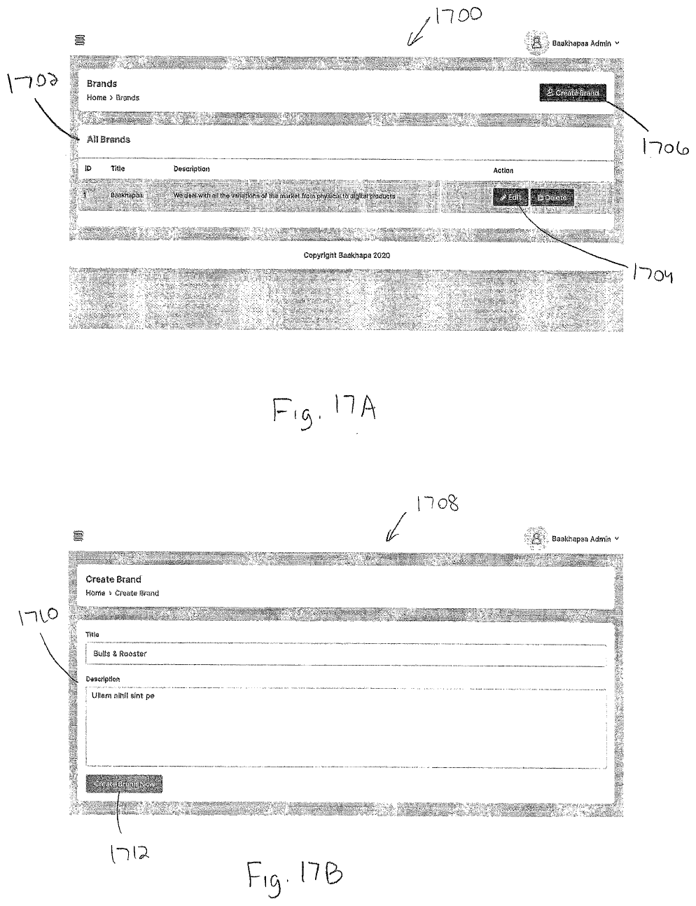

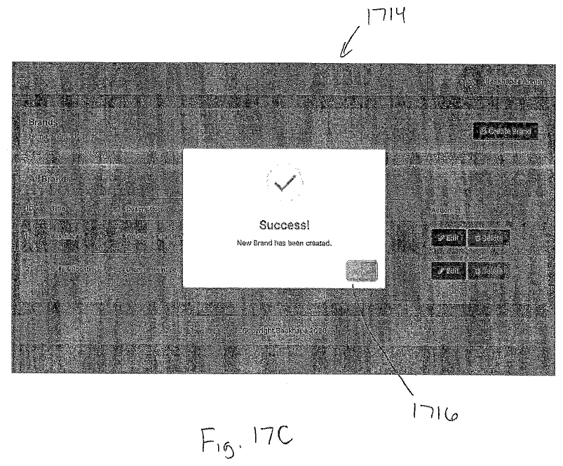

Referring now also to FIGS. 15A-15C in the drawings, various screenshots of the category feature of the present invention are illustrated. FIG. 15A best illustrates the category overview screen 1500, which preferably includes category list 1502, editing options 1504 and creation button 1506. Category list 1502 preferably includes information such as the category ID, title, and description, although more information may be presented in alternative embodiments of the present invention. Editing options 1504 preferably allow a user to either edit or delete an existing category, so long as that user has the permission assigned to do so. Additionally, again assuming the user permission, creation button 1506 will direct a user to a new page when engaged, such that a new category may be created.

FIG. 15B best illustrates creation page 1508, where a user can preferably create a new category, including information 1510. Under the preferred embodiment of the present invention, information 1510 includes the title and description of a category that the user is attempting to create. Once satisfied with the information 1510, a user may elect to confirm their creation, and once the confirmation is submitted, a user is preferably presented with confirmation screen 1512 as shown in FIG. 15C.

Confirmation screen 1512 preferably includes message 1514, upon which a user may be alerted to either the success or failure of their category creation.

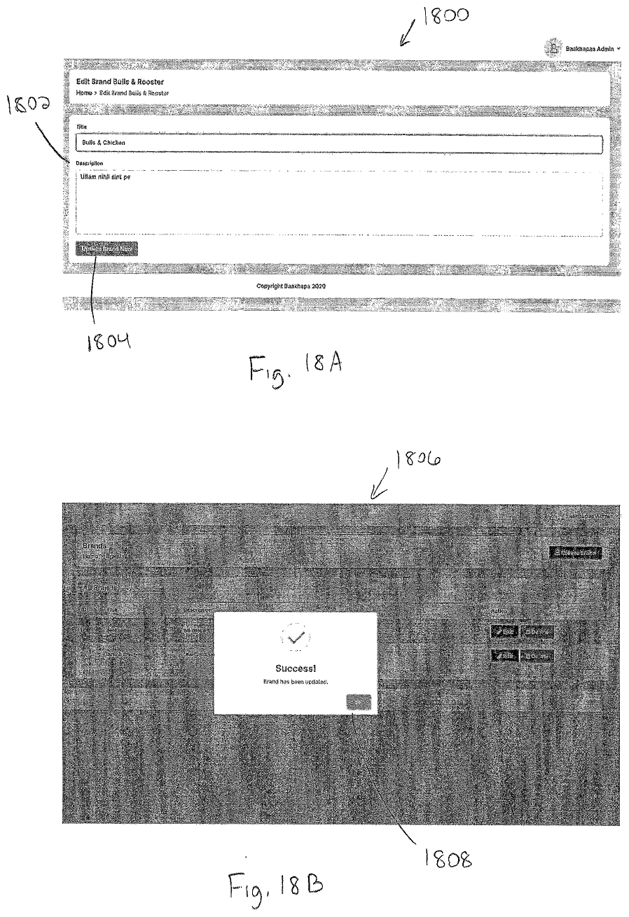

Referring now also to FIGS. 16A-16B in the drawings, the category editing feature of the preferred embodiment of the present invention is illustrated. Category editing page 1600 preferably includes information box 1602 and update button 1604. Information box 1602 preferably includes options to include a title and a description of the category. It should be appreciated that alternative embodiments of the present invention may include additional/alternative options to edit within the category feature. Under the preferred embodiment, a user may engage the update button 1604 to save the changes made, and then the user will be shown confirmation screen 1606. Confirmation screen 1606 preferably includes message 1608, which will either alert to user to an error with the update or show that the update was successful. Alternative embodiments may include an additional message if there is a specific error that needs to be corrected before proceeding, such as alerting the user that the title tab was left blank for example.

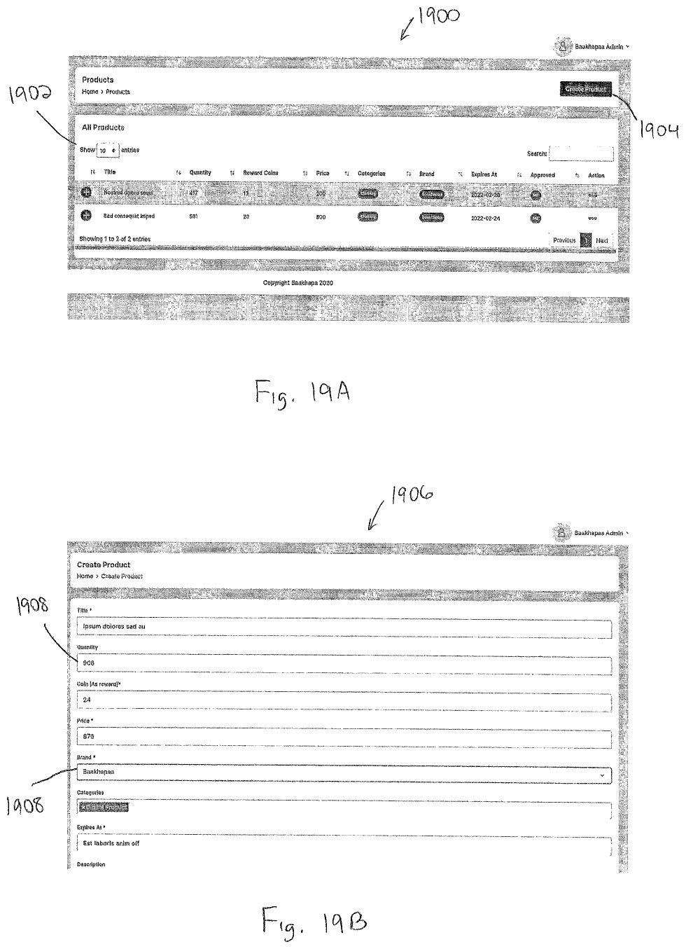

Referring now also to FIGS. 17A-17C in the drawings, various brand features of the preferred embodiment of the present invention are illustrated. Under the preferred embodiment, brand page 1700 includes brand information 1702, action tabs 1704, and creation button 1706. Brand information 1702 preferably includes a brand ID, title, and description, although it is possible that alternative embodiments include alternative or additional features. For example, a brand may include a brand image or logo within brand information 1702. Action tabs 1704 preferably include an edit option and a delete option, which are used to either modify or clear brands from the brand page 1700.

Under the preferred embodiment, when a user engages the creation button 1706, the user is redirected to creation page 1708. Creation page 1708 preferably includes brand information box 1710 and creation button 1712. The information entered by the user into brand information box 1710 is preferably the information that will be displayed in brand information 1702 once submitted. A user may preferably use creation button 1712 to submit their new brand creation. It should be appreciated that the text within the fields illustrated in the above screenshots are merely illustrative, and that the information within the fillable fields will vary with every new brand creation. FIG. 17C best illustrates confirmation screen 1714, which preferably includes message 1716. Under the preferred embodiment, message 1716 will alert the user to either a successful brand creation or an error if there was an issue with the creation attempt.

Referring now also to FIGS. 18A-18B in the drawings, the preferred embodiment of a brand editing page is illustrated. Brand editing page 1800 preferably includes brand information 1802 and confirm update button 1804. While the embodiment illustrated in FIG. 18A shows brand information as including the title and description, it should be appreciated that alternative or additional information may be included on the brand page. Once a user is finished with the brand edits, engagement of the confirm update button 1804 will submit the changes to the edited brand. A user will then preferably be shown confirmation page 1806, which preferably includes message 1808 to alert the user to either a successful or unsuccessful submission of the updates.

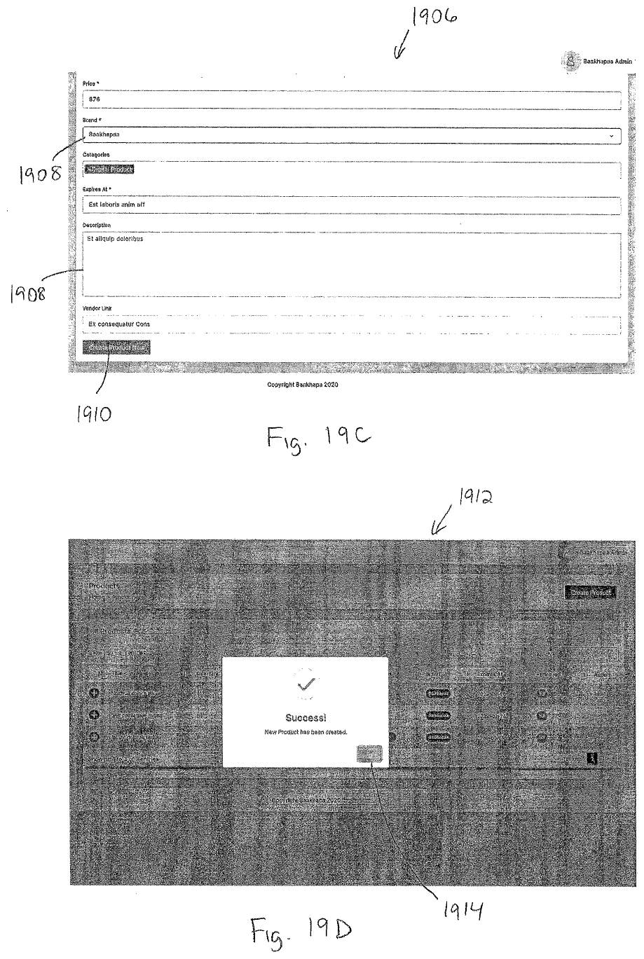

Referring now also to FIGS. 19A-19D in the drawings, various product screens are illustrated according to a preferred embodiment of the present invention. Product screen 1900 preferably includes product information 1902 and creation button 1904. Under the preferred embodiment, product information 1902 displays all products that have been added to the application, as well as various information about those products. For example, the product information 1902 may include title, quantity available, price, reward, category, brand, expiration date, and associated actions. It should be appreciated that alternative embodiments of the present invention may include fewer, additional, or alternative options in the product information feature. As shown in FIG. 19A, the products may vary in quantity, including some products becoming temporarily or permanently unavailable when stock runs out. The price category may vary in terms of currency displayed, including the possibility of providing a user with the option to change the currency displayed. Some alternative embodiments may even include the possibility of paying with digital currencies, such as various cryptocurrency. Additionally, the reward amount preferably provides the user with an in-app reward for their purchases, where those reward coins may be later used for the unlocking of seasons, or other various actions as discussed above. Preferably, a user may create a new product by engaging creation button 1904.

FIGS. 19B and 19C best illustrate the various features of creation page 1906. Under the preferred embodiment, creation page 1906 includes product information 1908 and create button 1910. Product information 1906 preferably represents the fillable information categories that will then be displayed on product screen as product information 1902. Similar to product information 1902, it should be appreciated that alternative embodiments of the present invention may include alternative product information 1908 as opposed to the exemplary options shown in FIGS. 19B and 19C. When a user completes the desired information entry, the user preferably may engage create button 1910 to confirm the product creation. Once submitted, the user is preferably presented with confirmation page 1912, which includes message 1914. Message 1914 preferably alerts the user to either a successful product creation or an error with the creation, and may further include a detailed description of why the product creation may have failed.

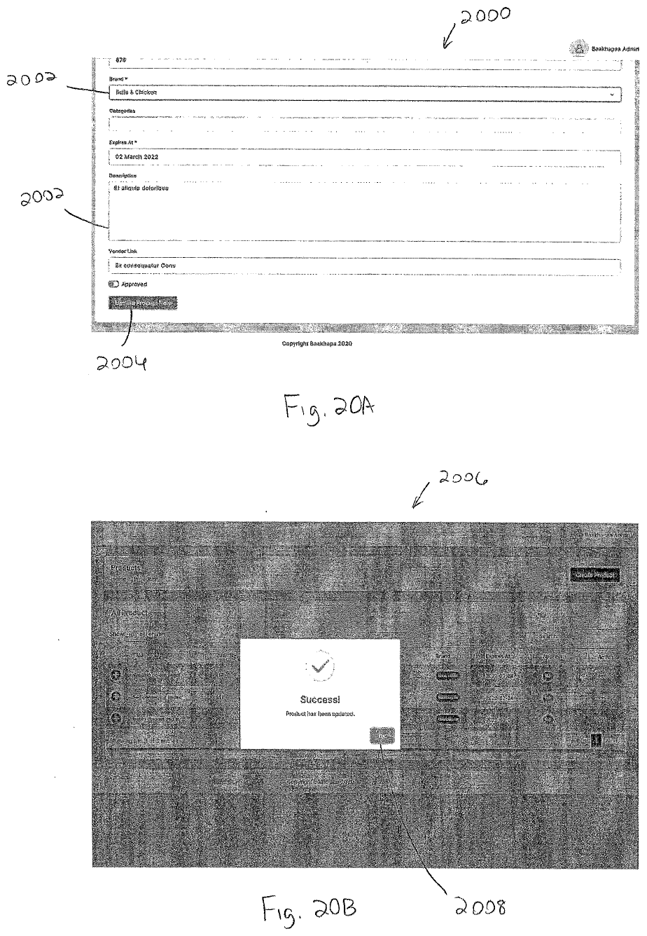

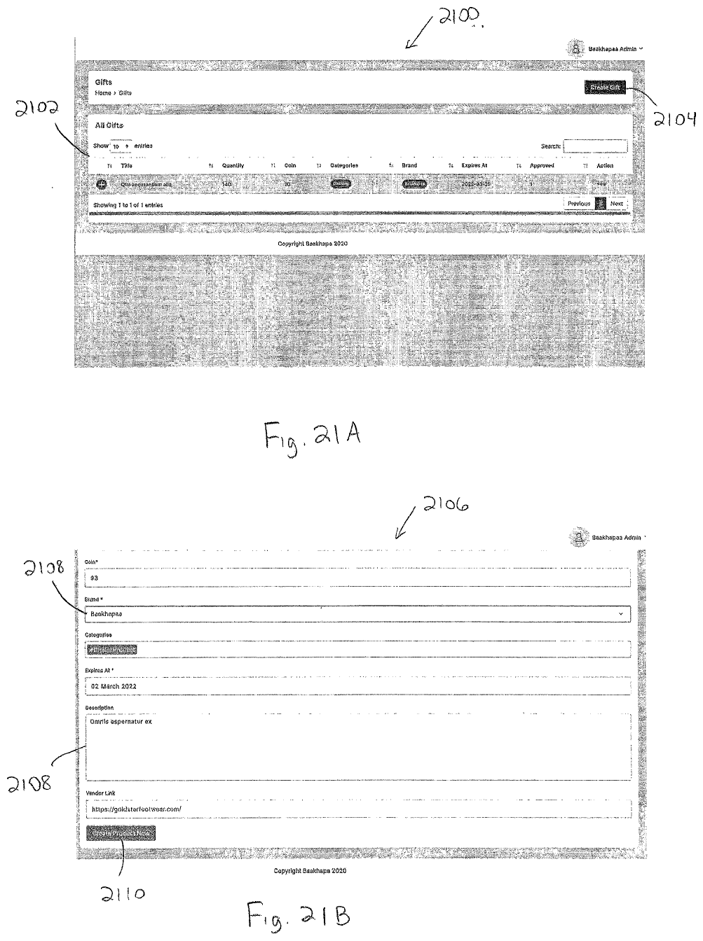

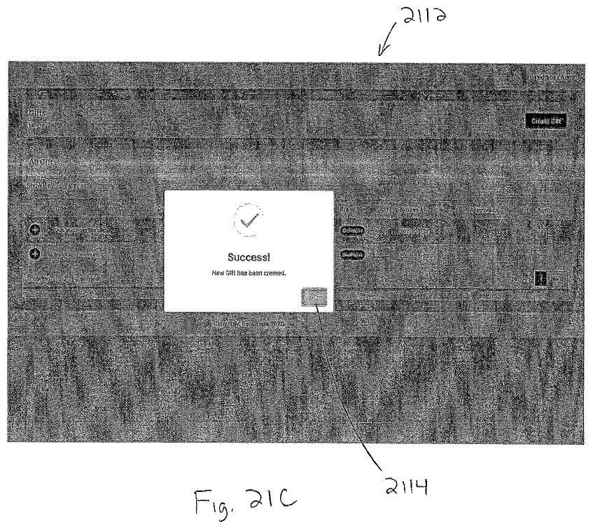

Referring now also to FIGS. 20A-20B in the drawings, the product editing screen is illustrated according to a preferred embodiment of the present invention. Editing screen 2000 is similar to creation page 1906, although the product information 2002 will preferably be filled in already upon accessing editing screen 2000. As such, a user preferably may then enter additional information, delete some information, or make changes to the product information 2002. When the user completes any desired product editing, they may engage update button 2004 to submit the product updates. Confirmation page 2006 is preferably displayed to the user once the updates are submitted, alerting the user to either a successful or unsuccessful product update.

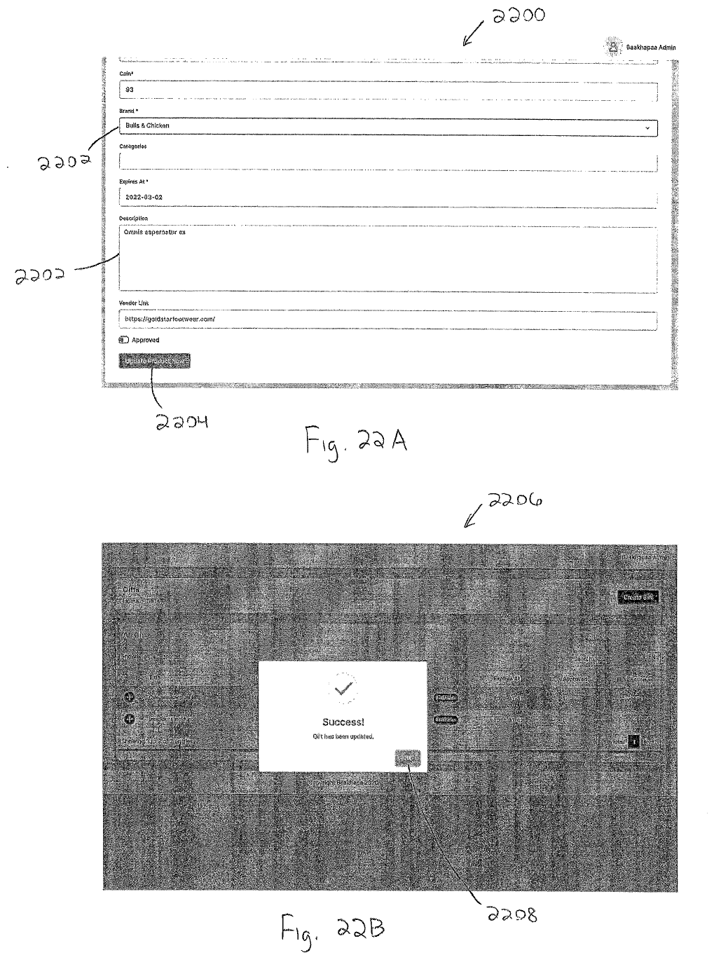

Referring now also to FIGS. 21A-21C in the drawings, various pages related to the gift feature of the present invention are illustrated according to a preferred embodiment. Gift screen 2100 preferably includes gift information 2102 and gift creation button 2104. Under the preferred embodiment, gift information 2102 includes a title, quantity available, cost, a category, brand, expiration date, and further action items. It should be appreciated that alternative embodiments may include fewer, additional, or alternative information as well. While preferably the gifts are purchased using reward coins from within the mobile application, it should be appreciated that alternative embodiments may have other forms of earning/acquiring gifts, such as being a reward for watching a certain number of episodes, or being able to combine reward coins and actual currency in some form.

Under the preferred embodiment, a user will be redirected to creation screen 2106 after engaging gift creation button 2104. Creation screen 2106 preferably includes gift information 2108 and creation confirmation button 2110. Gift information 2108 may include title, description, cost, and even a link to that particular vendor's website. Although FIG. 21B best illustrates example text and prices for gift information 2108, it should be appreciated that it is likely that every individual product will vary in at least some of this information. Once a user engages creation confirmation button 2110, the user is preferably shown confirmation screen 2112, which preferably includes message 2114. Message 2114 preferably alerts the user to either a successful gift creation or an error in gift creation, with the possibility of including what may have caused the error.

Referring now also to FIGS. 22A-22B in the drawings, a gift editing feature is illustrated according to a preferred embodiment of the present invention. Gift editing page 2200 is preferably similar to creation screen 2106 in that it includes editable gift information. Gift information 2202 is illustrated similar to gift information 2108, however there has been an example edit to the brand and categories information tabs. It should be appreciated that this text is merely illustrative and that the editing screens will have various information included depending on the embodiment shown and the gift being edited. A user may preferably engage gift editing button 2204 to submit and save the edits made to the gift. Upon button 2204 engagement, a user will preferably be shown confirmation screen 2206. Confirmation screen 2206 preferably includes message 2208 which, again, may be a message alerting the user to either a successful or unsuccessful submission of data.

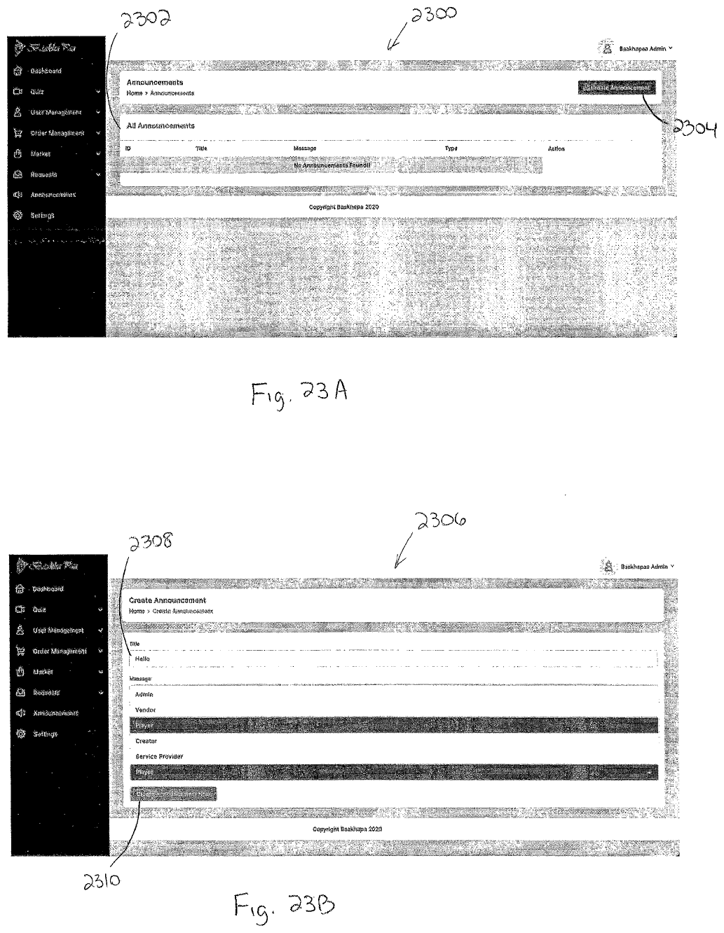

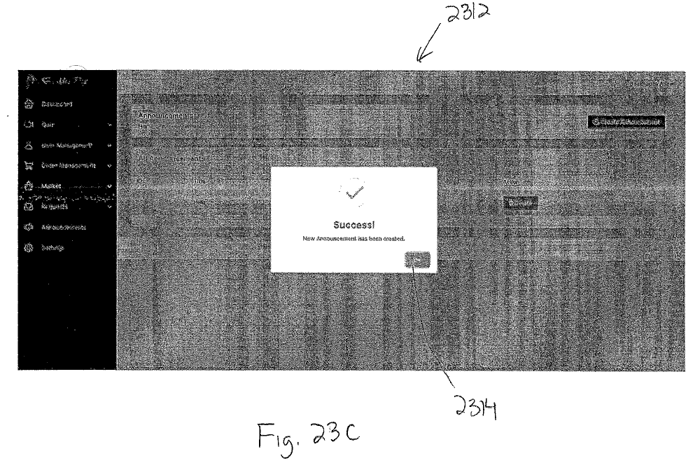

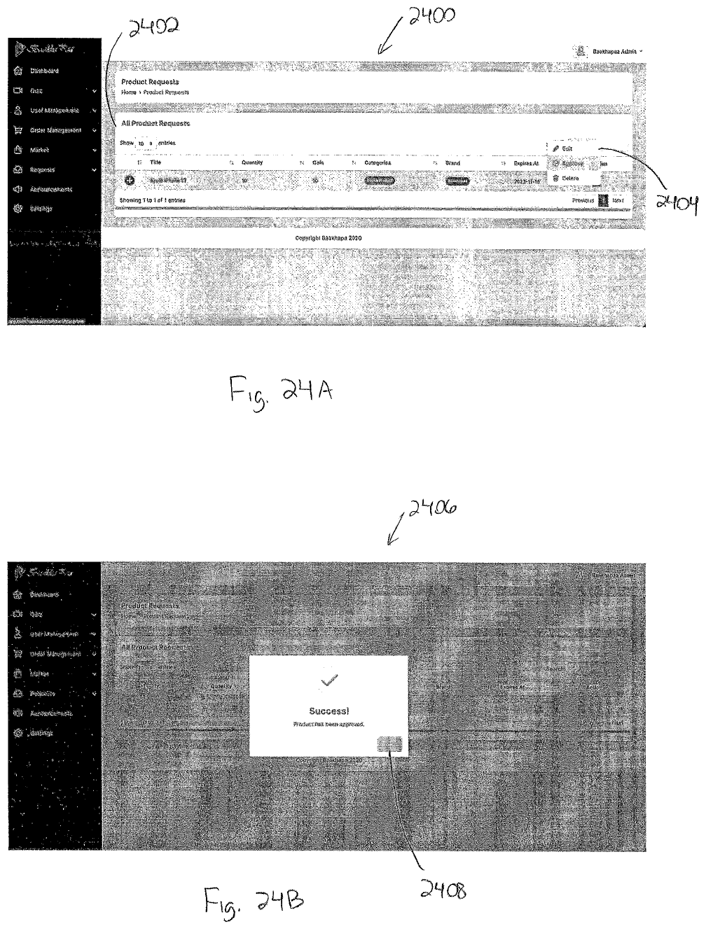

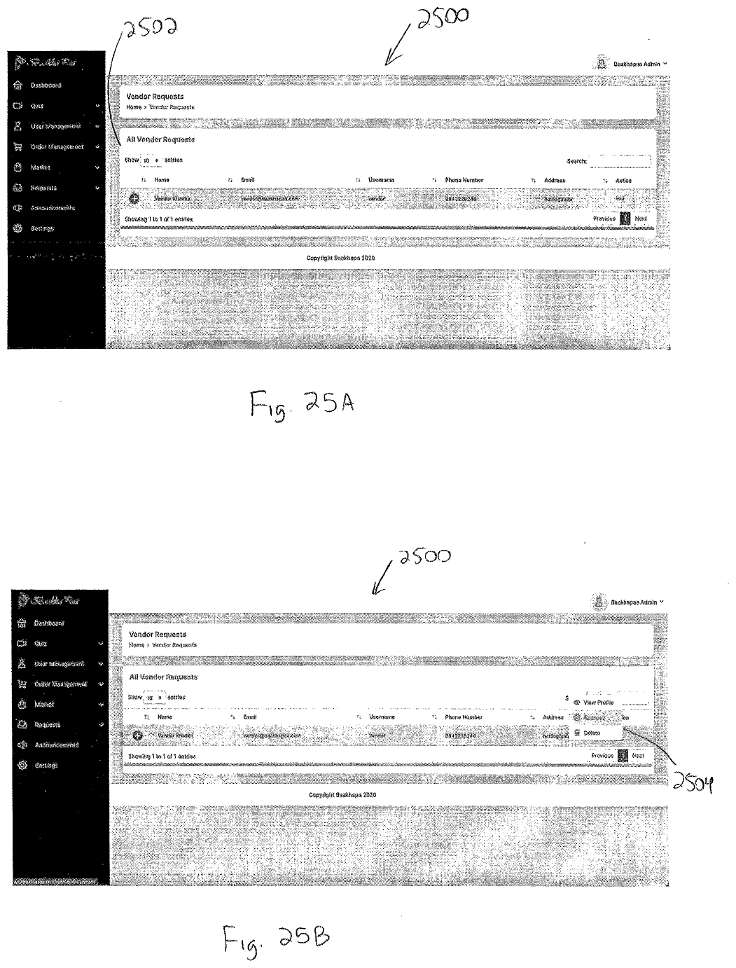

Referring now also to FIGS. 23A-23C in the drawings, an announcement feature is illustrated according to a preferred embodiment of the present invention. Under the preferred embodiment, announcement page 2300 includes announcement list 2302 and creation button 2304. Although announcement list 2302 is illustrated in FIG. 23A as having no current announcements, it should be appreciated that any current announcement would preferably be shown in that location, along with the title, message, and type of announcement. These announcement elements are best illustrated in the creation screen of FIG. 23B. When a user engages creation button 2304, they are preferably prompted with creation page 2306. Under the preferred embodiment, creation page 2306 includes announcement information 2308 and creation button 2310. Announcement information 2308 preferably includes the information that is to be displayed in announcement list 2302, such as title, message, and type. It should be appreciated that alternative embodiments may include further features of the announcement section, such as including images, links, or other features within a single announcement. Preferably, when a user is satisfied with the message creation information on creation screen 2306, the user may engage the creation button 2310 to submit the announcement creation. Upon submission, a user is preferably presented with confirmation screen 2312, including message 2314 to either alert the user to a successful announcement creation or an error with the announcement creation.

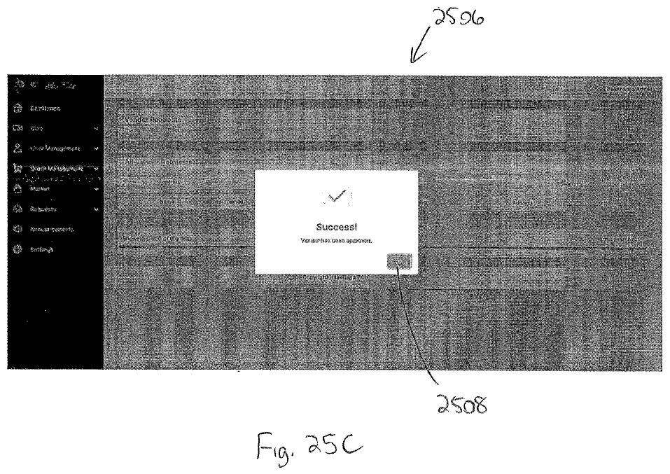

Referring now also to FIGS. 24A-24B in the drawings, a product request feature is illustrated according to a preferred embodiment of the present invention. Request page 2400 preferably includes request information 2402 and action tab 2404. Under the preferred embodiment, a user may submit a request to have their product added to the marketplace of the mobile application. A user product request preferably includes information such as the product title, the quantity available, cost, the brand and category the product fits within, and finally an expiration date. It should be appreciated that alternative embodiments of the present invention may include additional, less, or alternative information requirements when submitting a request. Action tab 2404 preferably provides an admin user with options to select either editing, approving, or deleting a product request. It should be appreciated that alternative embodiments may include additional admin options for action tab 2404, such as the ability to message the user that submitted that request in order to either recommend edits or request further information. Confirmation page 2406 preferably appears when the admin member engages some button on action tab 2404. After engagement, the admin member is preferably presented with message 2408, confirming which action was taken, such as approval, deletion, or editing complete. It should be appreciated that alternative embodiments may include additional options on the message, such as a cancel action button.

Referring now also to FIGS. 25A-25C in the drawings, a vendor request feature is illustrated according to a preferred embodiment of the present invention. Request page 2500 preferably includes vendor information 2502 and action tab 2504. Under the preferred embodiment, vendor information 2502 is submitted by the potential vendor and includes the name, email, username, phone number, and address of the potential vendor. It should be appreciated that alternative embodiments may include more information, such as a short message or description that may aid the admin member in determining whether to accept or decline the vendor request. Action tab 2504 preferably includes options to approve or delete the request, as well as an option to view the potential vendor's profile. When an action to either approve or delete the vendor request is selected, the user is preferably presented with confirmation screen 2506, which includes message 2508. Message 2508 preferably either confirms the approval/deletion, or alerts the user to an error with the selection. Under the preferred embodiment, when a vendor is approved, the vendor may then submit further requests to have products added to the marketplace. It should be appreciated that alternative embodiments of the present invention may include an integrated vendor/product approval process, similar to that of the preferred embodiment, but with the ability to have a pre-approved set of products already included for that specific vendor.

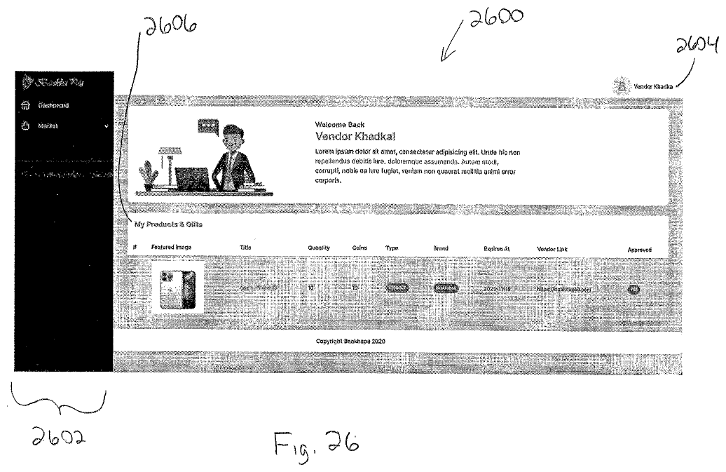

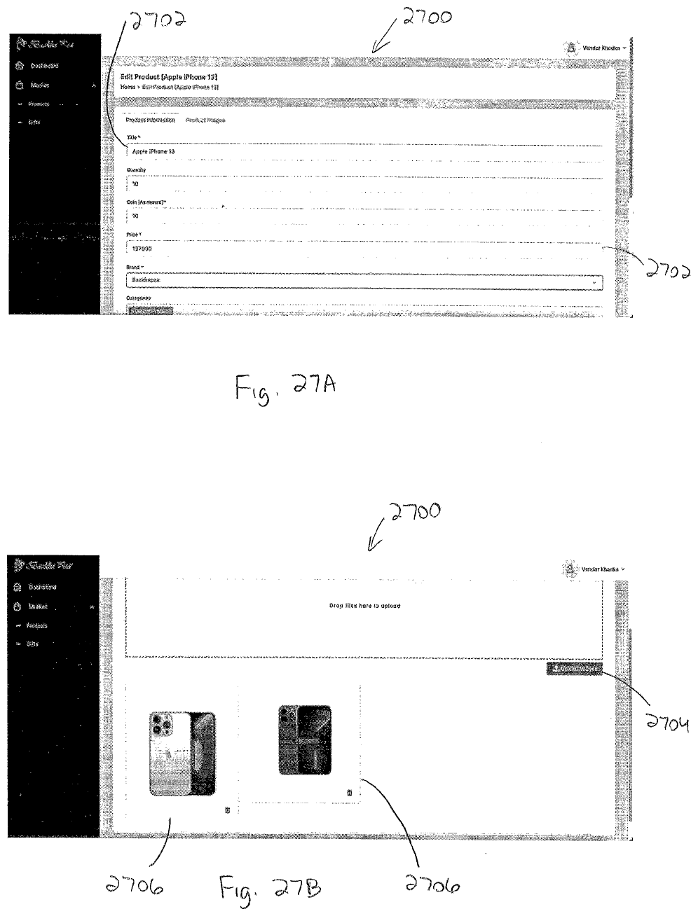

Referring now also to FIG. 26 in the drawings, a vendor profile page is illustrated according to a preferred embodiment of the present invention. Profile page 2600 preferably includes option tab 2602, account information 2604, and associated items 2606. It should be appreciated that alternative embodiments of the present invention may include further features, such as a profile picture, image, or other graphic associated with that vendor. Account information 2604 preferably includes text indicating which account is signed in or the option to login/register if there is no account currently signed in. Further account information 2604 may include a drop-down menu with access to further options, such as signing out, editing the account information, or viewing settings. Options tab 2602 preferably includes links to redirect the user to other features of the present invention, such as the dashboard or the marketplace. It should be appreciated that options tab 2602 may be presented in various ways to different users, depending on their permissions within the present invention. Associated items 2606 preferably include all of the vendor's associated products and gifts that are either currently in the marketplace or were in the marketplace in the past. It should be appreciated that alternative embodiments may present the option to have past marketplace listings removed from the associated items 2606. Additionally, alternative embodiments may include a “coming soon” section of the associated items 2606, such that users may be alerted to future marketplace items.

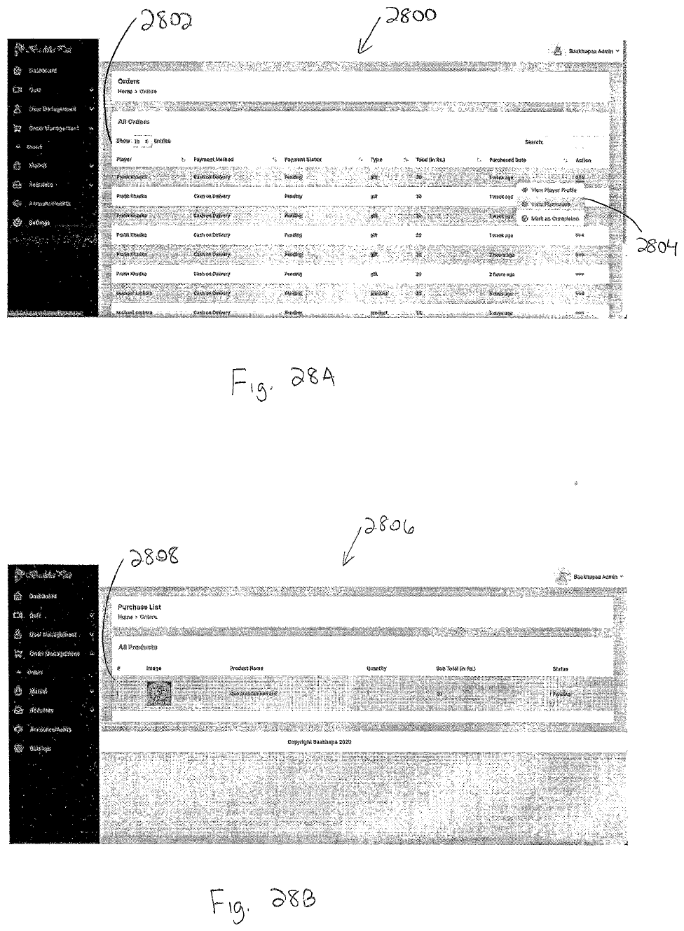

Referring now also to FIGS. 27A-27B in the drawings, a product editing feature is illustrated according to a preferred embodiment of the present invention. Editing page 2700 preferably includes product information 2702, upload option 2704, and product images 2706. Product information 2702 preferably includes item-specific information, such as title, cost, and brand, but may also include other editable information in alternative embodiments, such as a description or product instructions. Product images 2706 are included under the preferred embodiment to provide a user with a view of the product prior to purchase. However, it should be appreciated that alternative embodiments of the present invention may have no images present if the vendor does not feel that they are necessary. Additionally, it should be appreciated that any number of product images may be included, and those are added to the page using the upload option 2704. It should further be appreciated that admin members may have the ability to remove images at their discretion in accordance with the rules and regulations of the present invention.

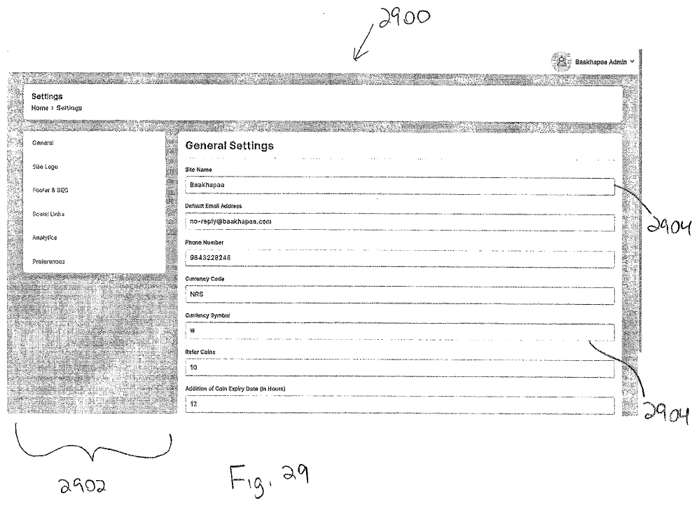

Referring now also to FIGS. 28A-28B in the drawings, an order history feature is illustrated according to a preferred embodiment of the present invention. Order history 2800 preferably includes order list 2802 and action tab 2804. Order list 2802 preferably includes details of each user purchase, such as the associated user, the payment method and status, the type of purchase, cost, and the purchase date. It should be appreciated that the order list may have a sort option, where a user could sort by specific details within the order list. Action tab 2804 preferably includes selectable options for a user to view that player's profile, the purchase itself, or to mark the order as completed. It should be appreciated that alternative embodiments may include further actions, such as messaging a user about the status of their order, or any other required actions.

Under the preferred embodiment, a user that has selected the action of viewing purchases will be redirected to purchase list 2806. Purchase list 2806 preferably includes items 2808 that were included in that individual purchase. For example, the purchase illustrated in FIG. 28B had only a single item in it, shown as a pending status. It should be appreciated that this purchase is merely illustrative and that other purchases made within the present invention may include any number of items purchased in a transaction.

Referring now also to FIG. 29 in the drawings, a settings feature is illustrated according to a preferred embodiment of the present invention. Settings page 2900 preferably provides the admin user with a variety of options 2902 for editing purposes, such as general settings, logos, links, and other information that may be necessary to optimize performance of the present invention. Each of these options 2902 may include editable information 2904, as illustrated in FIG. 29. It should be appreciated that this information 2904, such as the site name and contact information, will vary depending on which option 2902 is selected under the settings page.

It is apparent that a system and application with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for streaming digital content, comprising:
a mobile device;
a mobile application, comprising:
a form of digital content;
at least one quiz, the quiz relating to the digital content;
a reward subsystem; and
a marketplace; and
a backend application;
wherein the mobile application is configured for operation on the mobile device.

2. The system of claim 1, wherein the digital content is video content, comprising:
at least one season, the season including at least two episodes.

3. The system of claim 1, wherein the quiz is prompted at the conclusion of the related digital content.

4. The system of claim 1, the reward subsystem comprising:
a reward currency;
wherein a user is provided the reward currency upon successful completion of the quiz.

5. The system of claim 4, wherein the reward currency expires after an allotted time, the time being set by an administrative user of the system.

6. The system of claim 1, the marketplace comprising:
a gift section; and
a product section;
wherein the gift section is configured such that a user may purchase an item using a reward currency; and
wherein the product section is configured such that a user may purchase an item using real currency.

7. The system of claim 1, the backend application comprising:
a dashboard page containing user data;
at least two account type registration options;
a series of creation options; and
a series of editing options;
wherein the series of creation options and the series of editing options are configured such that a user may control the content available on the mobile application.

8. The system of claim 1, further comprising:
a user upload section;
wherein the user upload section is configured such that a user of the mobile application may upload their own created content.

9. A method for providing a digital content driven reward system, comprising:
providing a mobile application for use on a mobile device;
providing digital content to the mobile application;
creating a quiz relating to the digital content;
prompting a user with the quiz upon the user completion of viewing digital content;
providing the user with a reward upon successful completion of the quiz; and
providing the user with an item marketplace, the item marketplace configured such that a user may exchange their reward for various items.
